(19) United States
(12) Patent Application Publication
(10) Pub. No.: US 2026/0225734 A1
(43) Pub. Date: Aug. 6, 2026

(54) AUTONOMOUS ROBOTIC SYSTEM FOR AIRCRAFT WINGWALKING OPERATIONS

(71) Applicants: Kyoochul Lee, Covington, KY (US); Huzefa Dossaji, Bellevue, KY (US); Jon Taylor, Loveland, OH (US); David Ladnier, Versailles, KY (US)

(72) Inventors: Kyoochul Lee, Covington, KY (US); Huzefa Dossaji, Bellevue, KY (US); Jon Taylor, Loveland, OH (US); David Ladnier, Versailles, KY (US)

(21) Appl. No.: 19/631,684

(22) Filed: Mar. 27, 2026

Related U.S. Application Data
(63) Continuation-in-part of application No. 19/014,147, filed on Jan. 8, 2025.
(63) Continuation-in-part of application No. 19/014,134, filed on Jan. 8, 2025.
(60) Provisional application No. 63/618,580, filed on Jan. 8, 2024.
(60) Provisional application No. 63/783,843, filed on Apr. 4, 2025.

(51) Int. Cl. B64F 5/60

(52) U.S. Cl. CPC B64F 5/60

(57) ABSTRACT

An automation system for aircraft wingwalking includes an at least one autonomous mobile robot. Each robot includes a mobility system for transport over airfield ground surfaces, sensor circuitry with proximity sensors to detect aircraft and obstacles, and cameras to capture environmental image data. A computing system executes instructions to detect aircraft presence, identify wingtips or other aircraft parts using sensor data, and control the mobility system to autonomously navigate and position adjacent to respective wingtip or other aircraft part. A wirelessly connected user-interface mobile device receives operator commands and transmits them to the robots. The mobile device includes a deployment control that causes the robots to identify wingtips or other aircraft parts, autonomously position themselves adjacent to them, and subsequently track and follow the wingtips or other aircraft parts as the aircraft moves. An indication system provides operator alerts based on obstacle detection during aircraft movement.

### CROSS-REFERENCE TO RELATED APPLICATIONS

This application claims priority to U.S. Provisional Patent Application Ser. No. 63/783,843, filed on Apr. 4, 2025, is a Continuation-in-Part Utility Patent application claiming priority to U.S. patent application Ser. No. 19/014,147, filed on Jan. 8, 2025, and is a Continuation-in-Part Utility Patent application claiming priority to U.S. patent application Ser. No. 19/014,134, filed on Jan. 8, 2025, which claims priority to U.S. Provisional Patent Application Ser. No. 63/618,580, filed on Jan. 8, 2024, all of which are incorporated by reference herein in their entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The present disclosure relates to autonomous robotic systems for ground operations at airports, and more particularly to an automation system employing autonomous mobile robots for performing aircraft wingwalking operations during taxiing or towing to prevent collisions with obstacles.

### 2) Description of Related Art

Ground operations at military, commercial, or other airports involve coordinated services and activities that occur on the ground to support the arrival, departure, maintenance, and overall operations of aircraft. When performed in a timely manner, ground operations help ensure that aircraft are properly handled upon landing, safely managed during the turnaround process, maintenance, repair, or overhaul processes, and are ready for takeoff at the next scheduled departure time.

Aircraft wingwalking is a safety procedure where personnel walk alongside an aircraft's wingtips during taxiing or towing to help prevent collisions with obstacles. This procedure is particularly relevant when aircraft are maneuvered through congested areas of an airport, such as hangars, gates, aprons, taxiways, and other locations where obstacles may be present in close proximity to the aircraft's wingspan. Wingwalkers serve as additional sets of eyes for pilots, tow operators, and marshalers monitoring the clearance between the aircraft's wingtips and surrounding structures, vehicles, and other aircraft.

Traditionally, wingwalking has been performed by human personnel who physically walk alongside the aircraft during ground movements. These personnel visually monitor the space around the wingtips and communicate with the pilot, tow operator or marshaler through hand signals, radio communications, or other means to alert them of potential collision hazards. However, such manual wingwalking operations are subject to various limitations, including human fatigue, distraction, limited visibility in adverse weather conditions or darkness, and the inherent variability in human attention and reaction times.

The turnaround process performed to prepare aircraft for departure involves numerous activities and personnel. Fuel trucks, baggage trains, water tankers, maintenance vehicles, catering trucks, de-icing rigs, airfield sweepers, pushback tugs, and various other vehicles and equipment are operated by airport employees and contractors to render their respective services. Coordinating all of these resources during the turnaround process presents logistical challenges, and traditional coordination measures have relied heavily on radio communications to direct vehicles and personnel to the appropriate locations.

Autonomous mobile robots have been developed for various applications in military, industrial and commercial settings. Such robots may employ various sensor configurations, navigation systems, and computing capabilities to perform tasks with reduced human intervention. The application of autonomous robotic systems to airport ground operations presents opportunities to address some of the challenges associated with traditional manual procedures.

### BRIEF SUMMARY OF THE INVENTION

According to an aspect of the present disclosure, an automation system for aircraft wingwalking is provided. The system includes at least one autonomous mobile robot configured to perform wingwalking functions by positioning themselves adjacent to respective sides of an aircraft and tracking the wingtips or other aircraft parts during aircraft movement. Each robot of the at least one autonomous mobile robot includes a mobility system operable to transport the robot over a ground surface of an airfield, the mobility system being omnidirectional to enable movement in multiple directions and zero-radius turns. Each robot further includes sensor circuitry supported by the mobility system, the sensor circuitry including a proximity sensor configured to capture proximity data indicative of a presence of the aircraft and obstacles adjacent to the robot, and at least one camera configured to capture image data of an environment surrounding the robot. Each robot also includes a computing system configured to execute computer-executable instructions to detect the presence of the aircraft based on the proximity data, identify different parts of the aircraft including wingtips using multi-modal sensor data, and control operation of the mobility system to autonomously navigate the airfield environment with centimeter precision localization and collision avoidance. The system further includes a user-interface mobile device wirelessly connected to the at least one autonomous mobile robot, the mobile device configured to receive commands from an operator and display information captured by the robots. The mobile device includes a summon control that, when activated, causes the at least one autonomous mobile robot to navigate to a location associated with the mobile device. The mobile device includes a deployment control that, when activated, causes the at least one autonomous mobile robot to identify aircraft parts and autonomous position themselves adjacent to the pre-defined position to perform wingwalking, and subsequently track and follow a specific aircraft part as the aircraft moves. The mobile device includes a complete control that, when activated, causes the at least one autonomous mobile robot to autonomously navigate to a charging station and plug into respective charging ports. The system also includes an indication system configured to provide alerts to the operator based on obstacle detection by the robots during aircraft movement.

According to other aspects of the present disclosure, the system may include one or more of the following features. The mobile device may be configured to display semantic information showing alerts for different parts of the aircraft including left wing, right wing, tail, and ground, enabling the operator to acknowledge risk of aircraft movements. The mobile device may be configured to display surround information including real-time sensing information comprising camera footage and three-dimensional LIDAR footage to provide detailed information around the aircraft. The indication system may include robot onboard LED alerts, robot sound alerts, mobile device display alerts, and headset sound alerts that are synchronized to indicate obstacle proximity. The indication system may be configured such that when an obstacle is detected in a pathway of the aircraft, the robot onboard LEDs change color to orange or red, robot sound alerts activate, a corresponding section of the mobile device semantic information display changes to orange or red, and headset sound alerts activate. The system may further include a headset paired to the mobile device and configured to provide audible alerts to the operator. The sensor circuitry may include a light detection and ranging sensor having a laser light source and photodetectors configured to detect reflected laser light from objects on the airfield. The computing system of each robot may be configured to identify different parts of the aircraft including fuselage, wings, tails, and landing gears using multi-modal sensor configuration and perception algorithms. The at least one autonomous mobile robot may be configured to autonomously navigate in airfield environments including hangars, gates, aprons, taxiways, and runways, both indoors and outdoors, and in any lighting and weather conditions.

According to another aspect of the present disclosure, a method for automated aircraft wingwalking is provided. The method includes receiving, at an orchestration system, a summon command from a mobile device associated with a tow tractor. The method includes dispatching, by the orchestration system, a plurality of autonomous mobile robots to the mobile device and tow tractor that issued the summon command. The method includes autonomously navigating, by the at least one autonomous mobile robot, to the tow tractor and entering a standby state. The method includes receiving, at the at least one autonomous mobile robot, a deployment command from the mobile device. The method includes identifying, by each robot of the at least one autonomous mobile robot, a respective wingtip or other part of an aircraft to be towed. The method includes autonomously positioning, by each robot, adjacent to the respective identified wingtip or other aircraft part. The method includes tracking, by each robot, the respective wingtip or other aircraft part in real-time and autonomously following the wingtip or other aircraft part while the aircraft is moving during towing by the tow tractor. The method includes displaying, on the mobile device, semantic information and surround information captured by the at least one autonomous mobile robot. The method includes issuing visual and audible alerts from the robots and the mobile device according to detected obstacle conditions. The method includes receiving, at the at least one autonomous mobile robot, a complete command from the mobile device. The method includes autonomously navigating, by the at least one autonomous mobile robot, to a charging station and plugging into respective charging ports.

According to other aspects of the present disclosure, the method may include one or more of the following features. Displaying semantic information may include displaying alerts for four different parts of the aircraft comprising left wing, right wing, tail, and ground. Displaying surround information may include displaying real-time camera footage and three-dimensional LiDAR footage. Issuing visual and audible alerts may include synchronizing robot onboard LED alerts, robot sound alerts, mobile device display alerts, and headset sound alerts. The method may further include, when an obstacle is detected in a direction of aircraft movement, changing robot onboard LEDs to orange or red, activating robot sound alerts, changing a corresponding section of the mobile device semantic information display to orange or red, and activating headset sound alerts. The orchestration system may be configured to manage multiple pairs of robots and multiple mobile devices, receiving summoning commands from mobile devices and dispatching pairs of robots to the mobile devices that issue the commands.

According to another aspect of the present disclosure, an autonomous mobile robot for aircraft wingwalking is provided. The robot includes a mobility system operable to transport the robot over a ground surface of an airfield. The robot includes sensor circuitry supported by the mobility system, the sensor circuitry including a light detection and ranging sensor having a laser light source and a plurality of photodetectors configured to detect reflected laser light from objects on the airfield, at least one camera configured to capture visual and infrared image data, contact sensors configured to sense contact with objects, and a GPS/IMU sensor configured to provide positioning and orientation data. The robot includes a computing system configured to execute computer-executable instructions to detect the presence of an aircraft based on proximity data from the sensor circuitry, identify different parts of the aircraft including wingtips or other aircraft parts using multi-modal sensor data and perception algorithms, control operation of the mobility system to autonomously navigate the airfield environment with centimeter precision localization and collision avoidance, and track and follow a wingtip or other part of the aircraft during aircraft movement. The robot includes a wireless transceiver configured to communicate with a user-interface mobile device to receive commands and transmit sensor data. The robot includes an indication system including onboard LEDs and sound emitters configured to provide alerts based on obstacle detection.

According to other aspects of the present disclosure, the robot may include one or more of the following features. The robot may be configured to autonomously navigate to a charging station and plug into a charging port in response to a complete command received via the wireless transceiver. The robot may be configured to autonomously navigate to a location associated with a mobile device in response to a summon command received via the wireless transceiver. The robot may be configured to identify a wingtip or other part of an aircraft and autonomously position itself adjacent to the wingtip or other aircraft part in response to a deployment command received via the wireless transceiver. The computing system may be configured to identify different parts of the aircraft including fuselage, wings, tails, and landing gears. The robot may be configured to operate in airfield environments including hangars, gates, aprons, taxiways, and runways, both indoors and outdoors. The indication system may be configured such that when an obstacle is detected in a direction of a wingtip or other aircraft part being tracked, the onboard LEDs change color to orange or red and sound alerts activate.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates an isometric view of an autonomous mobile robot for aircraft wingwalking, according to aspects of the present disclosure.

FIG. 2 depicts an at least one autonomous mobile robot performing wingwalking operations with an aircraft and an operator, according to an embodiment.

FIG. 3 depicts a mobile device displaying a user interface with semantic and surround information screens, according to aspects of the present disclosure.

FIG. 4 depicts the mobile device of FIG. 3 displaying surround information views for the wingwalking automation system, according to an embodiment.

FIG. 5 illustrates a flowchart of a method for using robots in an aircraft wingwalking automation system, according to aspects of the present disclosure.

FIG. 6 depicts a top-down view of an airport with an airfield, aircraft, and associated infrastructure, according to an embodiment.

FIG. 7 illustrates an isometric view of an autonomous robot configured for ground operations at an airport, according to aspects of the present disclosure.

FIG. 8 illustrates an isometric view of an alternate embodiment of the autonomous robot of FIG. 7, according to an embodiment.

FIG. 9 illustrates a flowchart of a method of inspecting an aircraft with an autonomous robot, according to aspects of the present disclosure.

FIG. 10 illustrates a flowchart of a method of inspecting a region of an airfield for foreign-object debris, according to an embodiment.

FIG. 11 depicts a perspective view of an autonomous robot inspecting a portion of an aircraft on an airfield, according to aspects of the present disclosure.

FIG. 12 illustrates a reference image of a portion of an aircraft known to be free of damage, according to an embodiment.

FIG. 13 illustrates a captured image of a portion of an aircraft surface for damage comparison, according to aspects of the present disclosure.

FIG. 14 illustrates a graphical representation of a portion of an airfield with labeled foreign-object debris, according to an embodiment.

FIG. 15 illustrates an embodiment of a computing system configured with the disclosed systems and methods, according to aspects of the present disclosure.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

In this disclosure, a mobile device refers to a tablet, smartphone or other electronic device having a graphical user interface and having the ability to communicate wirelessly. Cameras described herein may be any camera such as a standard computer camera, thermal camera, fish-eye camera or any other camera capable of capturing images.

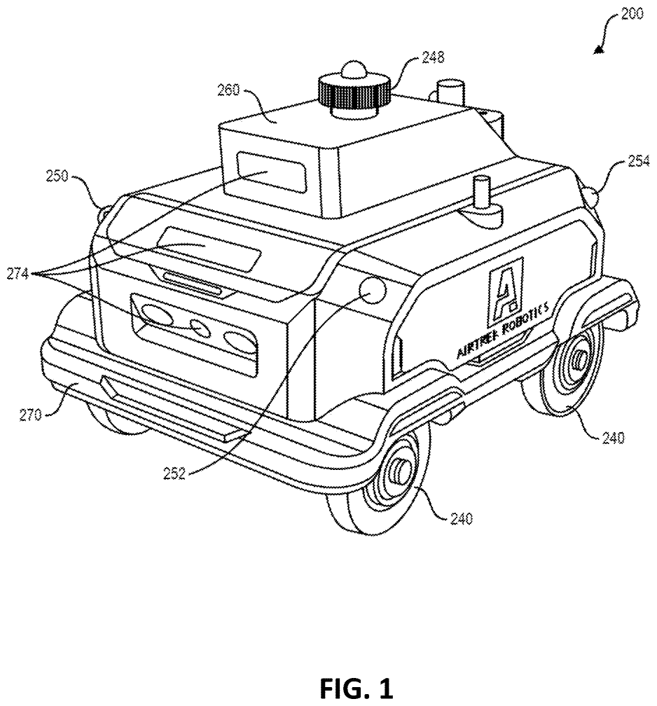

Referring to FIGS. 1-15, the present disclosure relates to an automation system for aircraft wingwalking that employs autonomous mobile robots to perform wingwalking functions during taxiing or towing operations. Wingwalking is a safety procedure where personnel walk alongside an aircraft's wingtips during taxiing or towing to prevent collisions with obstacles. The automation system described herein replaces human wingwalkers with at least one robot that positions itself adjacent to aircraft wingtips or other aircraft parts and track the wingtips or other aircraft parts during movement, thereby enhancing aircraft safety by reducing the risk of human errors while improving operational efficiency by enabling human staff to focus on higher-value activities.

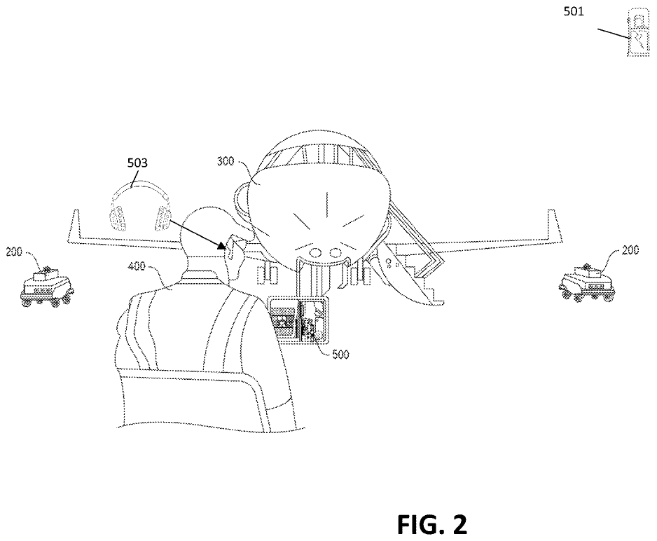

As shown in FIG. 2, the wingwalking automation system comprises at least one robot 200, a user-interface mobile device 500, a headset 503 paired or connected to the mobile device 500, and a charging station 501. An operator 400 uses the mobile device 500 to interface with the robots 200 and the system while an aircraft 300 is being moved. The mobile device 500 is wirelessly connected to the robots 200 for issuing commands. The headset 503 receives audio alerts synchronized with visual alerts displayed on the mobile device 500 and emitted by the robots 200.

Referring to FIG. 1, each robot 200 includes a plurality of wheels 240 driven by an electric motor powered by an onboard battery, internal combustion engine, or similar power source to transport the robot 200 over the surface of an airfield. Alternately, the plurality of wheels may include tracks driven by the plurality of wheels such as the tracks on a skid steer machine or military tank. The robot 200 may be omnidirectional, whereby the robot 200 may move in eight directions and can perform zero-radius turns. The robot 200 uses centimeter precision localization for autonomous navigation in the airfield environment. The robot 200 can autonomously navigate both indoor and outdoor airfield environments including hangar, gate, apron, taxiway, and runway areas, and in any lighting or weather conditions.

With continued reference to FIG. 1, the robot 200 includes sensor circuitry comprising a laser light source 248, photodetectors 250, 252, 254, a GPS/IMU sensor 260, contact sensors 270, and cameras 274. The cameras shown on the lower portion of 274 are for detecting foreign object debris and surface degradation. The laser light source 248 and photodetectors 250, 252, 254 form a light detection and ranging (LiDAR) sensor that captures proximity data indicative of the presence of the aircraft 300 and other objects adjacent to the robot 200. The GPS/IMU sensor 260 is mounted to the surface of the robot 200 for navigation and positioning purposes. The contact sensors 270 are mounted to the robot 200 for sensing contact with an object. The cameras 274 allow visual and infrared monitoring during the day or at night.

The robot 200 can identify different parts of an aircraft including fuselage, wings, tails, and landing gears using multi-modal sensor configuration and perception algorithms. The robot 200 can perform pre/post-flight inspection to identify structural damage based on aircraft scanning data. The robot 200 can perform tarmac surface inspection to identify degraded conditions like foreign object debris (FOD), potholes, cracks, and lower line marking reflectivity. The robots 200 can pull other equipment across the airfield. The robot 200 can include a sweeper mat to remove FOD that is detected. The robots 200 can move other equipment such as Aircraft Ground Power Unit and equipment boxes from staging areas to where the equipment is needed. The wingwalking robots 200 can be integrated with tow tractors to control the tow tractors before human drivers react, such as decelerating speed when an obstacle is detected.

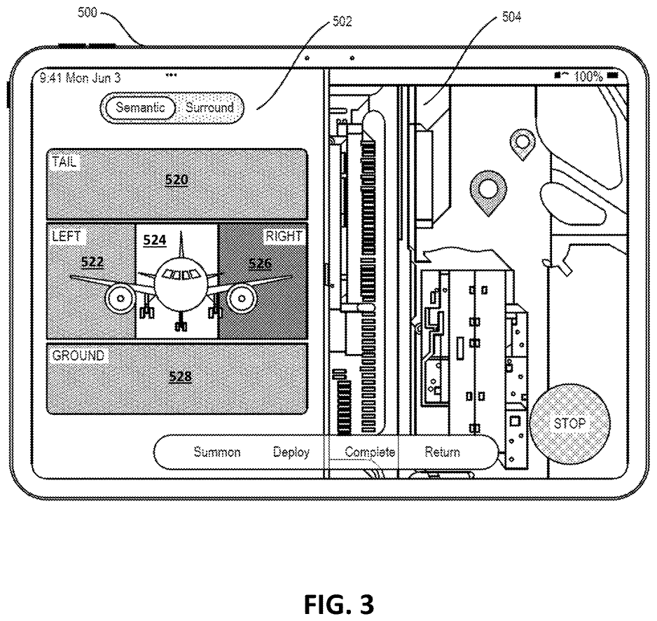

Referring to FIG. 3, the mobile device 500 displays a semantic information screen on a left pane 502 and a surround information screen on a right pane 504. The right pane 504 displays map information and indicates where the aircraft is at on a google map or similar map. The left pane 502 shows semantic information and alerts for four different parts of the aircraft: left wing, right wing, tail, and ground, so human operators can acknowledge the risk of the aircraft movements in an intuitive manner. The alert system is synchronized across robot onboard LEDs, robot sound alerts, the mobile device 500 semantic information display, and headset 503 sound alerts. The left pane 502 includes sections 520, 522, 524, 226, 528 which each pertain to a different part of the aircraft including the tail, left wing, aircraft center, right wing and ground. When an obstacle is detected in the direction of the aircraft movement, the robot onboard LEDs turn orange or red, the robot sound alerts go off, the semantic information section for a part of the aircraft to which the obstacle is in the direct path of, one or more sections of sections 520, 522, 524, 226, 528 goes orange or red, and headset 503 sound alerts go off. For example, if the obstacle is in a direction of the right wing, then right wing section 526 of left pane 502 goes orange or red. If the obstacle is a direction of the tail, then the tail section 520 of the semantic information goes orange or red. The term goes orange or red refers to a change in color of the section by increasing the red or orange saturation.

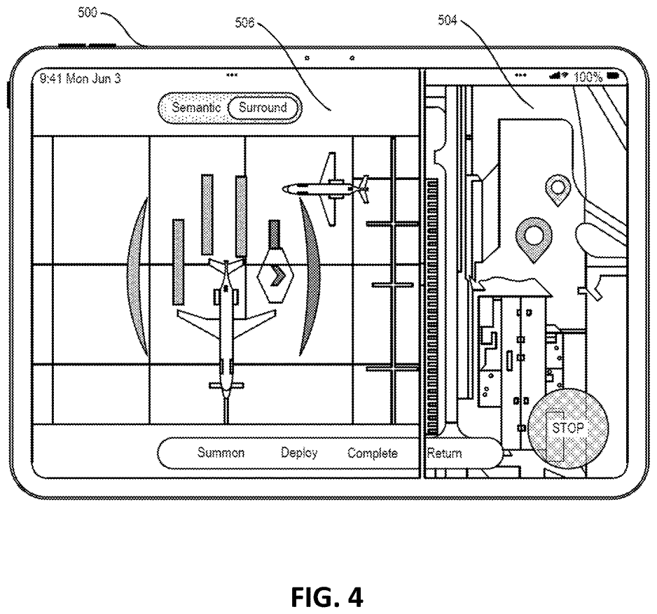

Referring to FIG. 4, the mobile device 500 displays surround information on left pane 506 and right pane 504. The surround information includes real-time camera footage and 3D LiDAR footage to provide more detailed information around the aircraft. The mobile device 500 displays divided screens for showing semantic information and surround information separately.

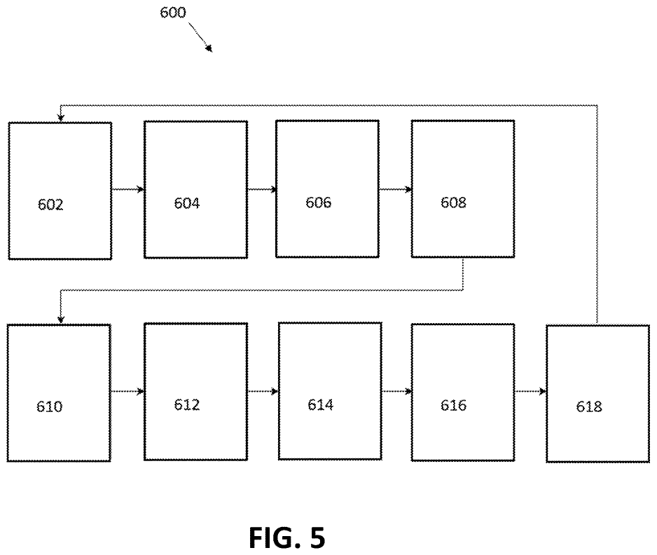

Referring to FIG. 5, a method 600 for using the automation system includes a step 602 where a tow operator clicks a summon button on the mobile device 500 attached to a specific tow tractor. Upon clicking the summon button, the robots 200 autonomously find their way to the summoning mobile device 500. In a step 604, an orchestration system receives the summoning command from the mobile device 500 and dispatches a pair of robots 200 to the mobile device 500 that issues the command. The system supports multiple pairs of robots 200 and multiple mobile devices 500 operating simultaneously. In a step 606, the pair of robots 200 autonomously navigate to the tow trailer and are placed in standby.

With continued reference to FIG. 5, in a step 608, the tow operator presses a deployment button on the mobile device 500. Upon clicking the deployment button, the robots 200 identify two wingtips or other aircraft parts of the aircraft 300 and position themselves next to each wingtip or other aircraft part. In a step 610, the pair of robots 200 identify each wingtip or other aircraft part and autonomously position themselves next to the respective wingtip or other aircraft part. In a step 612, the pair of robots 200 track the wingtips or other aircraft parts in real-time and autonomously follow the wingtips or other aircraft parts while the aircraft 300 is moving. The robots 200 track and follow the wingtips or other aircraft parts in real-time once the aircraft 300 starts moving. In a step 614, the semantic information and the surround information are displayed on the mobile device 500 and visual and audible alerts from the robots 200 and the mobile device 500 are issued according to the situation.

In a step 616, the tow operator clicks a complete button on the mobile device 500. Upon clicking the complete button, the robots 200 autonomously return to the charging station 501 and plug into charging ports. In a step 618, the pair of robots 200 autonomously move back to the charging station 501 and plug themselves into their respective charging ports. The robots 200 autonomously plug into charging ports similar to a Roomba vacuum cleaner. The method 600 can be repeated immediately or at a later time.

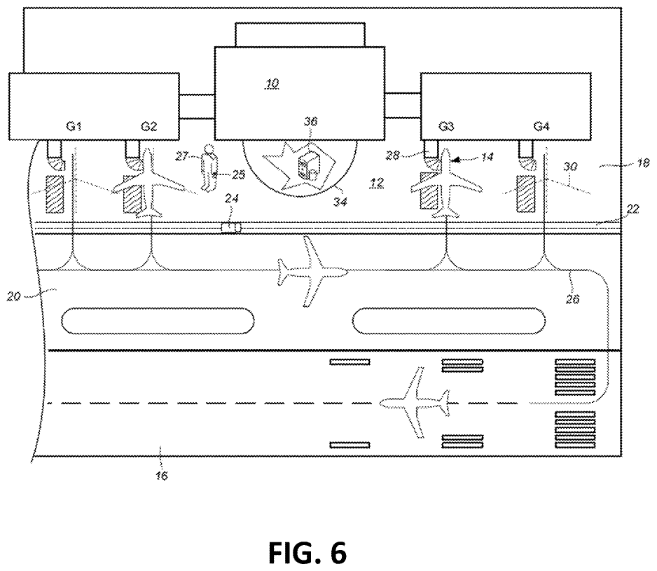

Referring to FIG. 6, an airport 10 comprises an airfield 12 used by aircraft 14 arriving at and departing from the airport 10. The airfield 12 includes a runway 16 along which aircraft 14 can take off and land, and an apron 18 on which aircraft 14 park during a turnaround process between arrival and departure at the airport 10. A taxiway 20 forms an access road for aircraft 14 to travel between the apron 18 and the runway 16, and a service road 22 is designated for use by service vehicles 24 involved in the turnaround process. The airport 10 includes a gate G1, a gate G2, a gate G3, and a gate G4 positioned along the apron 18. Taxi lines 26 guide aircraft 14 to locations where the aircraft 14 park and allow passengers to board and deplane via a jet bridge 28. Guide markers 30 are provided on portions of the airfield 12. Ground personnel 27 are depicted near the gate G2, and a smart watch 25 is associated with the ground personnel 27. A control center 34 houses a computing system 36 for managing flight schedule information and communicating with robots and other systems on the airfield 12.

The guide markers 30 can include electric conductors such as wires or circuitry buried beneath the surface of the airfield 12. The robot 200 can transmit sensor data to update a real-time digital twin of the airfield 12 for coordinating ground operations. The computing system 36 can distribute content generated as part of the digital twin over a local area network or wide area network to robots, service vehicles 24, and portable communication devices such as the smart watch 25.

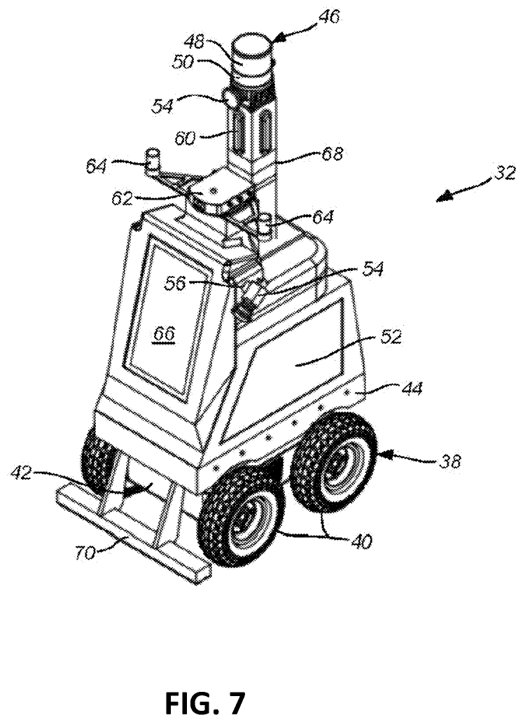

Referring to FIG. 7, a robot 32 includes a mobility system 38 comprising wheels 40 driven by an electric motor 42 to transport the robot 32 over the surface of the airfield 12. A chassis 44 is coupled to the mobility system 38 and supports sensor circuitry. The sensor circuitry includes a sensor 46 comprising a laser light source 48 and a photodetector 50. A computing system 52 processes sensor data and controls operations. A camera 54 is mounted on an adjustable mount 56 controlled by the computing system 52 to vary a sight line of the camera 54 between the surface of the airfield 12 and the underside of an aircraft fuselage. A light 60 illuminates portions of the airfield 12 or aircraft under inspection. A GPS module 62 determines accurate location data. Photodetectors 64 are positioned on the robot 32 to detect reflected laser light from various directions. A support structure 66 extends upward from the chassis 44 and supports various sensor components. A transceiver 68 facilitates wireless communications with the control center 34 or other remote terminal. A magnet 70 is suspended adjacent to the surface of the airfield 12 to magnetically attract ferromagnetic debris. The magnet 70 can be a permanent magnet or an electromagnet that can be selectively activated. The robot 32 can use a continuous track system instead of wheels 40 for mobility. The robot 32 is powered by an onboard battery, internal combustion engine, or similar power source.

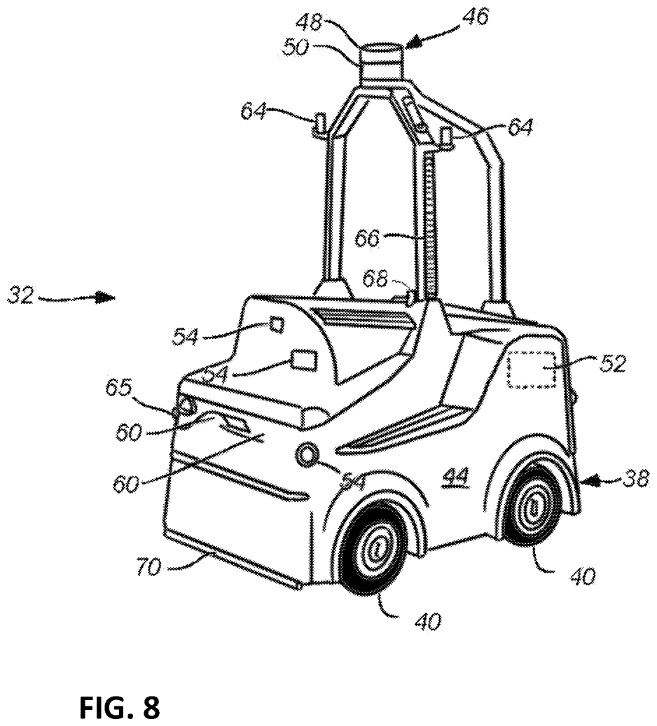

Referring to FIG. 8, an alternate embodiment of the robot 32 includes a proximity sensor 65 positioned on the chassis 44 to provide additional collision avoidance capability. The robot 32 can use ultrasonic, capacitive, or other types of proximity sensors as added defense against collisions. The navigation system can use virtual waypoints in a positioning system that uses data from navigation satellites or terrestrial transmitters.

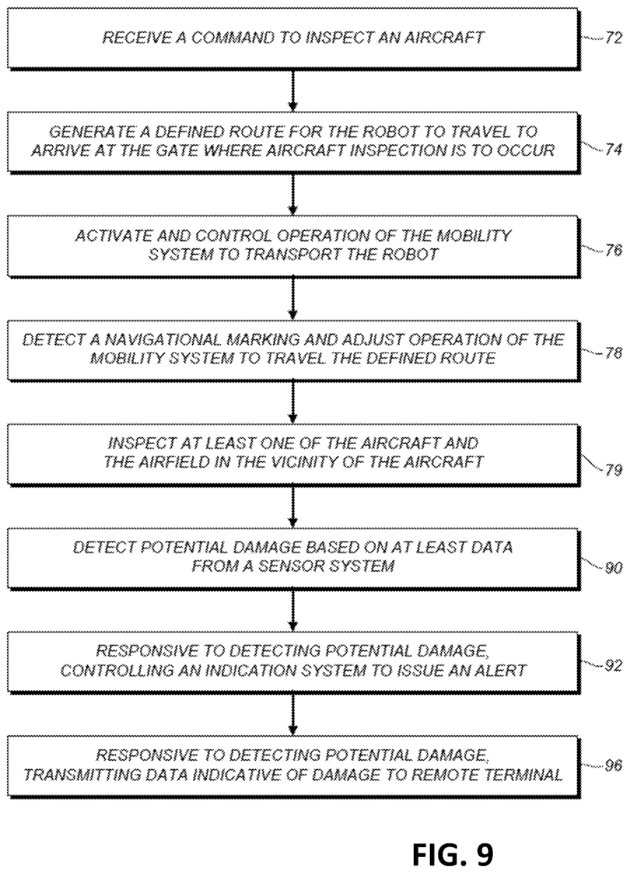

Referring to FIG. 9, a step 72 involves receiving a command to inspect an aircraft. A step 74 involves generating a defined route for the robot 32 to travel. A step 76 involves activating and controlling the mobility system 38. A step 78 involves detecting a navigational marking. A step 79 involves inspecting the aircraft and the airfield 12. A step 90 involves detecting potential damage. A step 92 involves controlling an indication system to issue an alert. A step 96 involves transmitting data indicative of damage to a remote terminal.

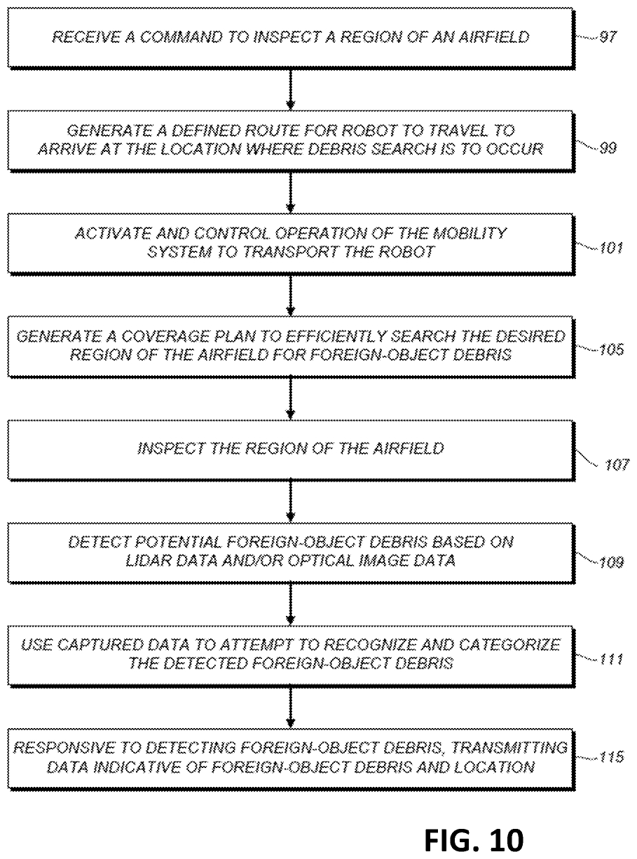

Referring to FIG. 10, a step 97 involves receiving a command to inspect a region of the airfield 12. A step 99 involves generating a defined route. A step 101 involves activating and controlling the mobility system 38. A step 105 involves generating a coverage plan. The robot 32 can execute coverage planning to generate a map of a path for searching a specified area of the airfield 12 for foreign-object debris. A step 107 involves inspecting the region of the airfield 12. A step 109 involves detecting potential foreign-object debris. A step 111 involves recognizing and categorizing the detected foreign-object debris. A step 115 involves transmitting data indicative of the foreign-object debris to a remote terminal. The robot 32 travels an adaptive route specific to the region of the airfield 12 to be inspected rather than following a fixed predefined route.

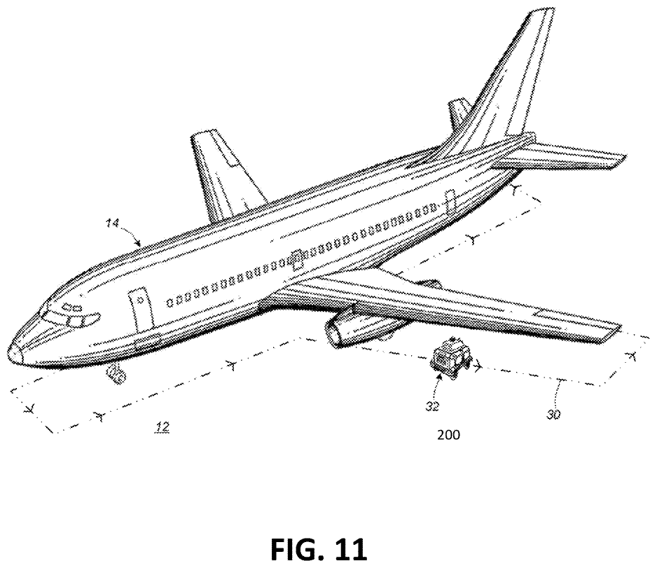

Referring to FIG. 11, the robot 200 is shown inspecting a portion of the aircraft 14 located on the airfield 12. The guide markers 30 define a boundary or inspection path around the aircraft 14.

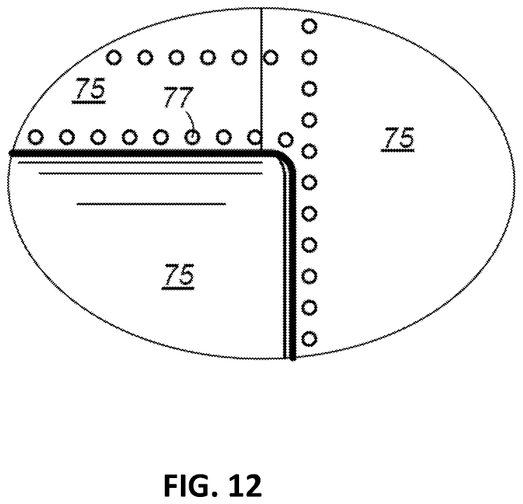

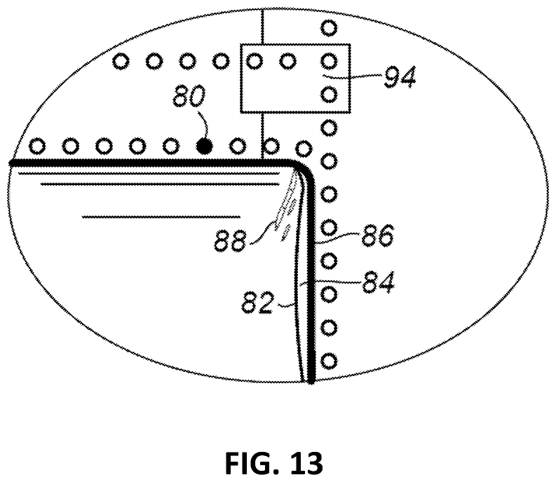

Referring to FIG. 12, a reference image depicts body panels 75 and rivets 77 of an aircraft surface known to be free of damage. Referring to FIG. 13, a captured image depicts a damaged rivet 80, a body panel deformity 82, a gap 84, an undamaged edge 86, fluid 88, and a metal patch 94. The computing system 52 can use generative artificial intelligence instructions to modify optical inspection instructions based on manually identified damage confirmations. The camera 54 can capture an image of ground personnel's face for facial recognition or execute a code-scanner function to read a barcode or magnetic strip on a security badge.

The robot 200 can inspect markings on the airfield 12 for retroreflectivity compliance with FAA regulations and ASTM E1710 standards. A light source for marking inspection is positioned at approximately 0.65 meters above the airfield 12 and the sensor at approximately 1.2 meters above the airfield 12 for ASTM E1710 compliance. The robot 200 illuminates a portion of the marking approximately 30 meters ahead for retroreflectivity testing.

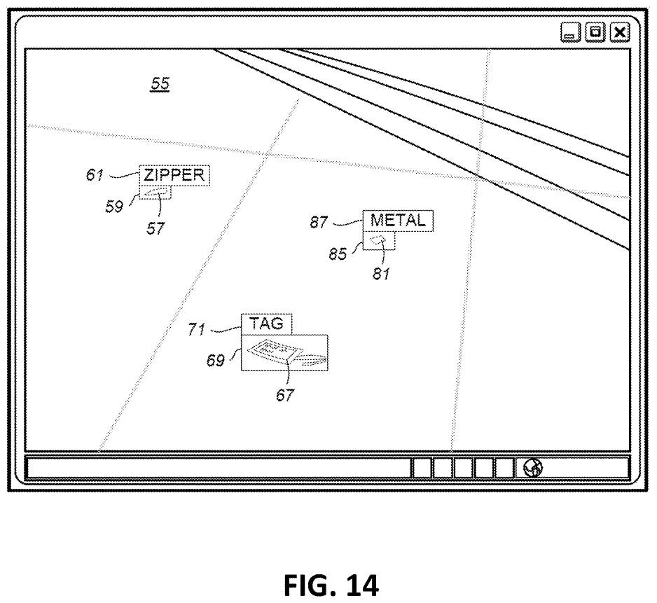

Referring to FIG. 14, a graphical representation 55 depicts a portion of the airfield 12 containing foreign-object debris labeled by the computing system 52. A zipper 57 is enclosed by a virtual rectangle 59 with a label 61 displaying the identification. A luggage tag 67 is enclosed by a rectangle 69 with a label 71. An unidentifiable object 81 is enclosed by a virtual rectangle 85 with a label 87 indicating a general category classification based on detected color.

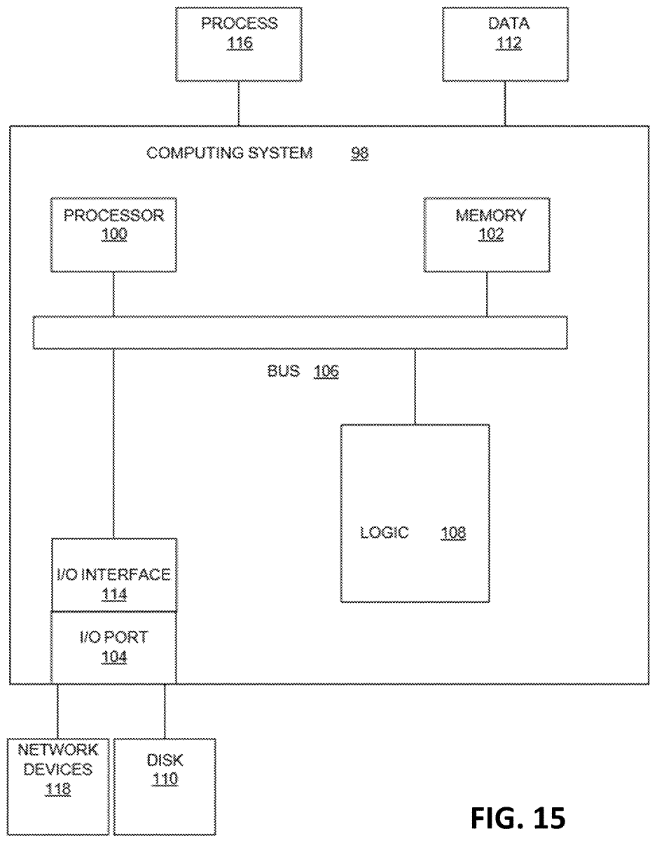

Referring to FIG. 15, a computing system 98 includes a processor 100, memory 102, an I/O port 104, a bus 106, logic 108, a disk 110, data 112, an I/O interface 114, a process 116, and network devices 118. The logic 108 is configured to control operation of the mobility system 38, sensors, cameras, GPS module 62, display device, transceiver 68, and other elements. A display device can be an LED computer screen within a weather-resistant protective case, an array of LED indicator lights, or an individual LED light source. A debris collector comprises at least one of a magnet, a vacuum, and a broom for collecting foreign objects.

Referring to FIG. 1, the robot 200 includes the wheels 240 driven by the electric motor powered by an onboard battery, internal combustion engine, or similar power source to transport the robot 200 over the surface of the airfield 12. Alternately, the wheels may include tracks driven by the wheels, such as the tracks on a skid steer machine or military tank. The wheels 240 are configured to provide omnidirectional movement capability, allowing the robot 200 to move in eight directions and to perform zero-radius turns. The robot 200 uses centimeter precision localization for autonomous navigation in the airfield environment.

With continued reference to FIG. 1, the robot 200 includes sensor circuitry comprising the laser light source 248 and a photodetector 250, a photodetector 252, and a photodetector 254. The laser light source 248 and the photodetectors 250, 252, 254 form a LiDAR sensor that captures proximity data indicative of the presence of the aircraft 300 and other objects adjacent to the robot 200. The photodetectors 250, 252, 254 are positioned at different locations on the robot 200 for detecting reflected laser light from various directions. A portion of the laser light emitted by the laser light source 248 that strikes an object on the airfield 12 is reflected back to the photodetectors 250, 252, 254, and a timer circuit measures the time for that reflected laser light to return to the photodetectors 250, 252, 254.

As further shown in FIG. 1, a contact sensor 270 is mounted to the robot 200 for sensing contact with an object. The contact sensor 270 provides tactile feedback when the robot 200 encounters physical contact with obstacles or other objects in the airfield environment. A camera 274 is mounted to the robot 200 and allows visual and infrared monitoring during the day or at night. The camera 274 captures images of the surrounding environment to support navigation and obstacle detection functions.

The robot 200 includes the GPS/IMU sensor 260 mounted to the surface of the robot 200 for navigation and positioning purposes. The GPS/IMU sensor 260 determines accurate location data by receiving signals from satellites and measures specific forces imparted on the robot 200 and angular velocities of components of the robot 200. The GPS/IMU sensor 260 enables the robot 200 to track motion and orientation for autonomous navigation across the airfield 12.

Referring to FIG. 2, the pair of robots 200 perform wingwalking operations with the aircraft 300. One robot 200 is positioned on a left side of the aircraft 300 adjacent to a left wingtip or other left side position, and another robot 200 is positioned on a right side of the aircraft 300 adjacent to a right wingtip other right side position. The positioning of each robot 200 enables the robots 200 to monitor clearance between the aircraft and obstacles during taxiing or towing operations.

With continued reference to FIG. 2, the operator 400 uses the mobile device 500 to interface with the robots 200 and the system while the aircraft 300 is being moved. The mobile device 500 is wirelessly connected to the robots 200 for issuing commands. The operator 400 wears the headset 503 that is paired or connected to the mobile device 500 for receiving audio alerts. The headset 503 receives audio alerts synchronized with visual alerts displayed on the mobile device 500 and emitted by the robots 200, providing the operator 400 with real-time audible feedback regarding obstacle detection and aircraft clearance status.

As further shown in FIG. 2, the charging station 501 is positioned in an upper right portion of the depicted scene. The robots 200 return to the charging station 501 after completing wingwalking operations. Upon receiving a complete command from the mobile device 500, the robots 200 autonomously navigate back to the charging station 501 and plug themselves into respective charging ports at the charging station 501.

The robots 200 autonomously navigate both indoor and outdoor airfield environments including hangar, gate, apron, taxiway, and runway areas. The robots 200 use centimeter precision localization and navigation algorithms to traverse the airfield environment. The robots 200 employ collision avoidance algorithms to detect and avoid obstacles encountered during navigation between the charging station 501 and the aircraft 300 wingtips.

Referring to FIG. 3, the mobile device 500 displays a user interface for the aircraft wingwalking automation system with a divided screen layout. The mobile device 500 screen is divided into two main sections: the semantic information on left pane 502 and the surround information on right pane 504. The divided screen layout enables operators to view both semantic information and surround information simultaneously during wingwalking operations.

With continued reference to FIG. 3, the semantic information on left pane 502 displays a schematic representation of an aircraft viewed from the front. The left pane 502 displays alerts for four different parts of the aircraft: left wing, right wing, tail, and ground. The left-wing zone is labeled on a left side of the schematic aircraft representation, and the right-wing zone is labeled on a right side of the schematic aircraft representation. The tail zone is labeled at a top portion of the schematic aircraft representation, and the ground zone is labeled at a bottom portion of the schematic aircraft representation. The arrangement of the four zones on the left pane 502 enables operators to acknowledge risk of aircraft movements in an intuitive manner by providing a spatial representation that corresponds to the physical orientation of the aircraft.

As further shown in FIG. 3, the surround information on right pane 504 occupies the right portion of the mobile device 500 display. The right pane 504 shows a detailed view of airport infrastructure and equipment, providing real-time sensing information around the aircraft. A location marker icon appears on the surround information screen 504 indicating a position reference. The right pane 504 provides more detailed information around the aircraft than the left pane 502 by displaying camera footage and 3D LiDAR footage captured by the robots 200.

With continued reference to FIG. 3, a navigation bar is positioned at a bottom of the mobile device 500 display. The navigation bar includes four command buttons labeled Summon, Deploy, Complete, and Return. The Summon button initiates a command for the robots 200 to navigate to the summoning mobile device 500. The Deploy button initiates a command for the robots 200 to identify the wingtips or other aircraft parts of the aircraft and position themselves adjacent to the respective wingtips or other aircraft parts. The Complete button initiates a command for the robots 200 to return to the charging station 501 and plug into charging ports. The Return button provides an additional navigation command for the robots 200.

As further shown in FIG. 3, a STOP button is positioned on the right pane 504. The STOP button provides emergency control functionality for the operator 400 to halt robot operations when circumstances require immediate cessation of movement. Toggle buttons labeled Semantic and Surround appear at a top of the display area, allowing the operator 400 to switch between the two information views. The top of the mobile device 500 display shows time and battery indicator information.

Referring to FIG. 4, the mobile device 500 displays a user interface with surround information for the aircraft wingwalking automation system. The mobile device 500 shows a split-screen view with a left pane 506 and a right pane 504. The information on left pane 506 occupies a left portion of the screen and presents a top-down view of aircraft on a grid pattern. The left pane 506 shows multiple aircraft representations with sensor coverage areas indicated by curved lines emanating from the aircraft positions. The sensor coverage areas depicted in the left pane 506 illustrate the detection range of the robots 200 positioned adjacent to the aircraft wingtips or other aircraft parts during wingwalking operations.

With continued reference to FIG. 4, the right pane 504 occupies a right portion of the screen and shows a detailed aerial or map view of an airport environment. The surround information on right pane 504 includes structures, pathways, and location markers that provide the operator 400 with contextual information about the surrounding airfield environment. The right pane 504 enables the operator 400 to visualize the position of the aircraft 300 relative to nearby obstacles, buildings, and other aircraft during taxiing or towing operations.

As further shown in FIG. 4, a toggle interface is positioned at a top of the screen and allows selection between Semantic and Surround viewing modes. The Surround option is selected in the depicted view, causing the mobile device 500 to display the surround information on left pane 506 and right pane 504 rather than the semantic information on pane 502. The bottom of the display includes control buttons labeled Summon, Deploy, Complete, and Return for commanding the wingwalking robots 200. A STOP button is positioned in a lower right corner of the interface within the surround information on right pane 504 for emergency control functionality.

The surround information includes real-time camera footage and 3D LiDAR footage captured by the robots 200. The camera footage provides visual imagery of the environment surrounding the aircraft 300 during wingwalking operations. The 3D LiDAR footage provides depth information and spatial mapping of objects in the vicinity of the aircraft 300 wingtips or other aircraft parts. The combination of real-time camera footage and 3D LiDAR footage in the left pane 506 and right pane 504 provides detailed situational awareness around the aircraft 300 during wingwalking operations, enabling the operator 400 to monitor clearance between the wingtips or other aircraft parts and obstacles with enhanced precision.

Referring to FIG. 5, the method 600 for using the wingwalking automation system begins with the step 602 where a tow operator clicks a summon button on the mobile device 500 attached to a specific tow tractor. Upon clicking the summon button, the robots 200 autonomously find their way to the summoning mobile device 500. The robots 200 use the sensor circuitry including the laser light source 248 and the photodetectors 250, 252, 254 to navigate through the airfield environment while avoiding obstacles encountered along the navigation path to the mobile device 500.

With continued reference to FIG. 5, the step 604 involves an orchestration system receiving the summoning command from the mobile device 500 and dispatching at least one robot 200 to the mobile device 500 and tow trailer that issues the command. The orchestration system receives summoning commands from mobile devices and dispatches pairs of robots to the issuing mobile device. The system supports multiple robots 200 and multiple mobile devices 500 operating simultaneously, enabling concurrent wingwalking operations across different locations on the airfield 12.

In the step 606, the pair of robots 200 autonomously navigate to the tow trailer and are placed in standby. The robots 200 use the GPS/IMU sensor 260 and the centimeter precision localization algorithms to navigate to the location of the tow trailer. Upon arriving at the tow trailer, the robots 200 enter a standby state and await further commands from the operator 400 via the mobile device 500.

As further shown in FIG. 5, the step 608 involves the tow operator pressing a deployment button on the mobile device 500. Upon clicking the deployment button, the robots 200 identify two wingtips or other aircraft parts of the aircraft 300 and position themselves next to each wingtip or other aircraft part. The robots 200 use the multi-modal sensor configuration including the camera 274 and the LiDAR sensor to identify the wingtips or other aircraft parts of the aircraft 300.

In the step 610, the pair of robots 200 identify each wingtip or other aircraft part and autonomously position themselves next to the respective wingtip or other aircraft part. One robot 200 positions itself adjacent to one part of the aircraft such as a left wingtip of the aircraft 300, and another robot 200 positions itself adjacent another part of the aircraft such as a right wingtip of the aircraft 300. The omnidirectional movement capability of the robots 200 enables precise positioning adjacent to the wingtips or other aircraft parts.

With continued reference to FIG. 5, the step 612 involves the pair of robots 200 tracking the wingtips or other aircraft parts in real-time and autonomously following the wingtips or other aircraft parts while the aircraft 300 is moving. The robots 200 track and follow the wingtips or other aircraft parts in real-time once the aircraft 300 starts moving. The tow operator drives the tow tractor and moves the aircraft 300 while the robots 200 maintain their positions adjacent to the respective wingtips or other aircraft parts throughout the movement. The robots 200 use the sensor circuitry to continuously monitor the position of the wingtips or other aircraft parts and adjust their movement to maintain the appropriate distance from the wingtips or other aircraft parts during taxiing or towing operations.

In the step 614, the semantic information and the surround information are displayed on the mobile device 500 and visual and audible alerts from the robots 200 and the mobile device 500 are issued according to the situation. The alert system is synchronized across robot onboard LEDs, robot sound alerts, the mobile device 500 semantic information display, and the headset 503 sound alerts. The robot onboard LEDs turn orange or red when an obstacle is detected in the direction of the aircraft or the pathway of the aircraft. When an obstacle is detected, the robot sound alerts go off, the semantic information on left pane 502 for the affected wing goes orange or red, and the headset 503 sound alerts go off simultaneously. The synchronized multi-channel feedback provides the operator 400 with redundant notification of obstacle detection through visual and audible channels.

As further shown in FIG. 5, the step 616 involves the tow operator clicking a complete button on the mobile device 500. Upon clicking the complete button, the robots 200 autonomously return to the charging station 501 and plug into charging ports. The complete button signals to the robots 200 that the wingwalking operation has concluded and initiates the return sequence.

In the step 618, the pair of robots 200 autonomously move back to the charging station 501 and plug themselves into their respective charging ports. The robots 200 autonomously plug into charging ports similar to a Roomba vacuum cleaner. The robots 200 use the navigation algorithms and the sensor circuitry to locate the charging station 501 and align with the charging ports for autonomous docking. The method 600 can be repeated immediately or at a later time for subsequent wingwalking operations.

Referring to FIG. 6, the airport 10 comprises the airfield 12 used by the aircraft 14 arriving at and departing from the airport 10. The airfield 12 includes the runway 16 along which the aircraft 14 take off and land. The apron 18 is positioned adjacent to the runway 16 and provides an area on which the aircraft 14 park during a turnaround process between arrival and departure at the airport 10. The taxiway 20 forms an access road for the aircraft 14 to travel between the apron 18 and the runway 16.

With continued reference to FIG. 6, the service road 22 is designated for use by a service vehicle 24 involved in the turnaround process to travel between service locations such as different gates. Traveling along the service road 22 allows the service vehicle 24 to substantially avoid the taxiway 20 and other parts of the apron 18 to minimize opportunities for collisions with the aircraft 14. The gate G1, the gate G2, the gate G3, and the gate G4 are positioned along the apron 18 to provide locations where the aircraft 14 park and allow passengers to board and deplane.

As further shown in FIG. 6, taxi lines 26 are provided on the taxiway 20 and extend onto the apron 18 to guide the aircraft 14 to locations on the apron 18 where the aircraft 14 park. The taxi lines 26 extend up to, and onto, the runway 16 to guide the aircraft 14 to or from the runway 16. The taxi lines 26 are composed of a reflective material such as a paint or other coating that contains glass beads, metallic flecking, or other reflective additive to improve visibility of the markings to pilots and the ground personnel 27 operating vehicles on the airfield 12.

With continued reference to FIG. 6, the jet bridge 28 extends from a terminal building to the aircraft 14 parked at the gates along the apron 18. The jet bridge 28 provides an enclosed walkway for passengers to board and deplane the aircraft 14. The jet bridge 28 serves as a reference point for the robot 200 during navigation operations on the airfield 12.

The guide markers 30 are provided on portions of the airfield 12 including the apron 18 and the runway 16. The guide markers 30 include electric conductors such as wires or circuitry buried beneath the surface of the airfield 12. The buried guide markers 30 transmit a signal, generate an electromagnetic field, or emit other types of transmission that the robot 200 detects and follows to a desired location. The guide markers 30 include virtual waypoints in a positioning system that uses data from navigation satellites in space orbit or from sub-orbital or terrestrial transmitters to triangulate or otherwise determine the location of the robot 200 on the airfield 12. The robot 200, with the aid of such positioning systems, navigates to different waypoints at the appropriate time to perform wingwalking and other functions.

As further shown in FIG. 6, the ground personnel 27 are depicted near the gate G2. The smart watch 25 is associated with the ground personnel 27 and receives alerts and notifications from the robot 200 and the computing system 36. The smart watch 25 displays information related to potential damage detected during aircraft inspection, foreign-object debris locations, and other operational data transmitted by the robot 200.

The control center 34 is positioned at the airport 10 and houses the computing system 36 for managing flight schedule information and communicating with the robot 200 and other systems on the airfield 12. The computing system 36 includes a database server for storing and managing flight schedule information, and an operation server in communication with the robot 200 that performs services on the airfield 12. The robot 200 transmits sensor data to the computing system 36 to update a real-time digital twin of the airfield 12 for coordinating ground operations. The computing system 36 distributes content generated as part of the digital twin over a local area network or wide area network to the robot 200, the service vehicle 24, and portable communication devices such as the smart watch 25 worn by the ground personnel 27.

Referring to FIG. 7, the robot 32 is configured for ground operations including wingwalking and aircraft inspection on the airfield 12. Additionally, the robot 32 may perform inspection of the aircraft surfaces as well as the airfield surface. The robot 32 includes the mobility system 38 that is operable to transport the robot 32 over the surface of the airfield 12 adjacent to the aircraft 14. The mobility system 38 includes the wheels 40 driven by the electric motor 42 powered by an onboard battery, internal combustion engine, or similar power source to transport the robot 32 over the surface of the airfield 12. The chassis 44 is coupled to the mobility system 38 and supports sensor circuitry and other components of the robot 32.

With continued reference to FIG. 7, the sensor 46 is supported by the chassis 44 and captures proximity data indicative of the presence of the aircraft 14 and other objects adjacent to the robot 32. The sensor 46 includes the laser light source 48 and the photodetector 50 that detects a portion of the laser light that is reflected by an object. The laser light source 48 emits laser light toward objects on the airfield 12, and a portion of the laser light that strikes an object is reflected back to the photodetector 50. A timer circuit measures the time for the reflected laser light to return to the photodetector 50, enabling calculation of the distance between the robot 32 and the detected object. Photodetectors 64 are positioned on the robot 32 to detect reflected laser light from various directions, providing expanded proximity detection coverage around the robot 32.

As further shown in FIG. 7, the computing system 52 is provided to the robot 32 for processing sensor data and controlling operations. The computing system 52 executes perception algorithms for multi-modal aircraft identification. The computing system 52 processes data from the sensor 46, the photodetectors 64, and the camera 54 to identify different parts of an aircraft including fuselage, wings, tails, and landing gears using multi-modal sensor configuration and perception algorithms. The computing system 52 controls operation of the mobility system 38 to transport the robot 32 along defined routes on the airfield 12 and to position the robot 32 adjacent to aircraft wingtips or other aircraft parts during wingwalking operations.

With continued reference to FIG. 7, the camera 54 is mounted on the adjustable mount 56 controlled by the computing system 52. The adjustable mount 56 varies a sight line of the camera 54 between the surface of the airfield 12 and the underside of the aircraft fuselage. The computing system 52 controls the adjustable mount 56 to direct the camera 54 toward different regions of the space between the surface of the airfield 12 and the underside of the aircraft fuselage during inspection operations. The camera 54 captures images of portions of the aircraft 14 during inspection and captures images of foreign-object debris present on the airfield 12.

As further shown in FIG. 7, the light 60 is provided to the robot 32 and is controlled by the computing system 52. The light 60 illuminates a portion of the airfield 12, a portion of the aircraft 14, or other object under inspection to allow for images to be captured by the camera 54 in low-light environments and at night. The GPS module 62 determines accurate location data by receiving signals from satellites. The GPS module 62 calculates the position of the robot 32 by comparing the time for signals from each satellite to reach the GPS module 62 and communicates the position to the computing system 36 at the control center 34.

With continued reference to FIG. 7, the support structure 66 extends upward from the chassis 44 and supports various sensor components including the sensor 46 and the photodetectors 64. The support structure 66 positions the sensor components at an elevated location on the robot 32 to provide an expanded field of view for proximity detection and obstacle avoidance. The transceiver 68 includes an antenna circuit that protrudes upward from the chassis 44 to facilitate wireless communications with the control center 34 or other remote terminal. The transceiver 68 transmits data indicative of potential damage to the aircraft 14 that has been detected during inspection to the computing system 36 for inclusion in a log entry specific to the aircraft 14 within an aircraft database.

As further shown in FIG. 7, the magnet 70 is coupled to the chassis 44 or the mobility system 38 and is suspended adjacent to the surface of the airfield 12 to magnetically attract ferromagnetic debris. The magnet 70 is a permanent magnet that exhibits magnetic properties at all times, or the magnet 70 is an electromagnet that is selectively activated when passing over a region of the airfield 12 to pick up ferromagnetic debris during an inspection. The magnet 70 collects ferromagnetic foreign-object debris from the surface of the airfield 12 as the robot 32 travels during wingwalking operations or dedicated debris collection operations.

Referring to FIG. 8, an alternate embodiment of the robot 32 is configured for detecting foreign-object debris present on the airfield 12 and inspecting markings applied to the airfield 12. The robot 32 includes the mobility system 38 comprising the wheels 40 that enable transport of the robot 32 over ground surfaces. The wheels 40 are positioned at a lower portion of the robot 32 to provide stable movement across the airfield environment. The robot 32 uses a continuous track system instead of the wheels 40 for mobility in certain configurations, providing enhanced traction and stability on varied airfield surfaces.

With continued reference to FIG. 8, the chassis 44 houses the computing system 52 and provides structural support for the various components of the robot 32. The computing system 52 processes sensor data and controls operations of the robot 32 during foreign-object debris detection and marking inspection tasks. The chassis 44 is coupled to the mobility system 38 and supports the sensor circuitry and other components mounted to the robot 32.

As further shown in FIG. 8, the sensor 46 is mounted on an elevated support structure 66 positioned above the chassis 44. The sensor 46 includes the laser light source 48 and the photodetector 50, which together form a light detection and ranging system for capturing proximity data. The laser light source 48 emits laser light toward objects on the airfield 12, and a portion of the laser light that strikes an object is reflected back to the photodetector 50. The photodetectors 64 are positioned on the support structure 66 to detect reflected laser light from objects on the airfield 12 from various directions, providing expanded proximity detection coverage around the robot 32.

With continued reference to FIG. 8, the camera 54 is mounted on the chassis 44 to capture optical images of the airfield 12 surface and foreign-object debris present on the airfield 12. The light 60 is provided to illuminate portions of the airfield 12 under inspection, enabling image capture in low-light environments and at night. The computing system 52 controls operation of the camera 54 and the light 60 to capture images of foreign-object debris and airfield markings during inspection operations.

As further shown in FIG. 8, the proximity sensor 65 is positioned on the chassis 44 to provide additional collision avoidance capability by detecting objects in close proximity to the robot 32. The proximity sensor 65 uses ultrasonic, capacitive, or other types of proximity sensing as added defense against collisions with objects on the airfield 12. The proximity sensor 65 emits an ultrasonic signal and senses reflected portions of that ultrasonic signal to detect the presence of an object in close proximity to the robot 32. The computing system 52 processes data from the proximity sensor 65 and controls operation of the mobility system 38 to stop or change the travel direction of the robot 32 in response to detecting an obstacle.

With continued reference to FIG. 8, the transceiver 68 extends upward from the chassis 44 and includes an antenna circuit for facilitating wireless communications with the control center 34 or other remote terminal. The transceiver 68 transmits data indicative of detected foreign-object debris and the location of the foreign-object debris to the computing system 36 for inclusion in a ground maintenance database. The transceiver 68 receives commands from the computing system 36 to conduct searches for foreign-object debris on specified regions of the airfield 12.

As further shown in FIG. 8, the magnet 70 is coupled to a lower portion of the robot 32 and is suspended adjacent to the ground surface to magnetically attract and collect ferromagnetic foreign-object debris during inspection operations. A debris collector comprises at least one magnet 70, a vacuum, and a broom for collecting foreign objects present on the ground surface of the airfield 12. The vacuum collects non-magnetic debris from the airfield 12 surface by generating suction to draw debris into a collection chamber. The broom sweeps debris from the airfield 12 surface using rotating bristles that direct debris toward a collection area. The computing system 52 controls operation of the debris collector to collect foreign-object debris detected by the sensor 46 and the camera 54 during inspection operations on the airfield 12.

Referring to FIG. 9, a method of inspecting the aircraft 14 with the robot 32 or robot 200 is depicted as a flowchart illustrating sequential operations from receiving an inspection command through navigation, inspection, damage detection, alert generation, and data transmission. The method enables the robot 32 to autonomously perform aircraft inspection tasks while communicating findings to external systems such as the computing system 36 at the control center 34.

The step 72 involves receiving a command to inspect the aircraft 14 parked at a gate such as the gate G3. The command is received via the transceiver 68 from the computing system 36 at the control center 34. The command is transmitted by the computing system 36 based on flight schedule information maintained for arriving and departing flights by the airport 10. The command includes flight schedule information such as the arrival time of the aircraft 14, gate information identifying the gate location where the robot 32 is to be deployed, the make and model of the aircraft 14, a tail number or other unique aircraft identifier, a list of operations to be performed, the identity of the ground personnel 27 on duty at the gate, and other information pertinent to the functions of the robot 32 during the inspection.

With continued reference to FIG. 9, the step 74 involves generating a defined route for the robot 32 to travel to arrive at the gate where aircraft inspection is to occur. The computing system 52 generates the defined route to be traveled by the robot 32 to reach the gate where the aircraft 14 to be inspected is located. The computing system 52 communicates with the GPS module 62 to determine a current location of the robot 32 relative to the gate and plots a course based on the relative location data. The defined route is generated by the computing system 52 based on the current location of the robot 32 when the command is received and is calculated as an optimal path in real-time to reach the destination. The defined route includes following portions of markings appearing on the airfield 12 and includes following direct paths that are not defined by markings on the airfield 12 when appropriate and possible without entering restricted regions of the airfield 12 that could interrupt ground operations.

As further shown in FIG. 9, the step 76 involves activating and controlling the mobility system 38 to transport the robot 32 along the generated route. The computing system 52 activates the electric motor 42 to drive the wheels 40. The computing system 52 controls operation of the mobility system 38 based on feedback from the GPS module 62 to transport the robot 32 along the defined route to the destination. While the robot 32 is underway under the control of the navigation system, the sensor 46 is operated by the computing system 52 to monitor for obstacles that pose a collision risk along the defined route. In response to sensing the presence of an obstacle, the computing system 52 controls the mobility system 38 to bring the robot 32 to a stop, change the defined path to navigate the robot 32 around the obstacle, or take other precautions to mitigate the potential for a collision between the robot 32 and the obstacle.

With continued reference to FIG. 9, the step 78 involves detecting a navigational marking and adjusting operation of the mobility system 38 to travel the defined route. The camera 54 or other sensor detects one or more navigational markings such as lines or other roadway markings on the service road 22, the taxi lines 26 for the gate, markings on the runway 16, virtual waypoints used by the GPS module 62, or other reference points so the robot 32 follows the defined route to the aircraft 14. The computing system 52 processes images of the guide markers 30 encountered by the robot 32 traveling to the desired destination and controls operation of the mobility system 38 to cause the robot 32 to travel a direction corresponding to the instruction conveyed by the guide markers 30.

As further shown in FIG. 9, the step 79 involves the robot 32 inspecting at least one of the aircraft 14 and the airfield 12 in the vicinity of the aircraft 14. Upon arriving at the gate, the computing system 52 commences a search for foreign-object debris, inspection of the aircraft 14, or other procedure. The robot 32 performs an inspection while traveling the entire distance of an inspection path defined by the guide markers 30, thereby inspecting the entirety of the aircraft 14. The computing system 52 uses data generated by the sensor 46 to detect the presence of the aircraft 14 and controls operation of the mobility system 38 to transport the robot 32 about the entire perimeter of the aircraft 14. The inspection involves using the sensor 46 to detect the presence of the aircraft 14 at the gate and to create a monochromatic representation of the surface of the airfield 12 and the exterior surface of the aircraft 14. The camera 54 captures images of the airfield 12 and the exterior surface of the aircraft 14 for processing by the computing system 52.

With continued reference to FIG. 9, the step 90 involves detecting potential damage based on at least data from a sensor system. The computing system 52 executes optical inspection instructions that compare captured images to reference images of corresponding portions of the aircraft 14 that are known to be free of damage and defects. Negligible differences between the captured images and the reference images that reflect expected wear and tear and are not considered safety critical are deemed to be acceptable, avoiding the issuance of an alert to the ground personnel 27 or other airport personnel. Detection of substantial differences triggers an alert by the indication system in response to the potential damage being detected by the computing system 52.

As further shown in FIG. 9, the step 92 involves controlling an indication system to issue an alert in response to detecting potential damage. The computing system 52 controls a display device of the indication system to issue the alert. The computing system 52 controls the mobility system 38 to stop the robot 32 at the location where the potential damage was detected. The alert includes a graphical display including an image of the portion of the fuselage that triggered the alert, with a circle or other shape, or highlighting to identify where the potential damage is found. The graphical display includes text that describes the nature of the potential damage, remedial action that is taken to address the potential damage, the location of the potential damage, or other information related to the potential damage.

With continued reference to FIG. 9, the step 96 involves transmitting data indicative of damage to a remote terminal responsive to detecting potential damage. The transceiver 68 transmits data indicative of the potential damage detected to a remote terminal such as the computing system 36 at the control center 34. The transceiver 68 transmits the data indicative of the potential damage to the smart watch 25 or another portable device worn by the ground personnel 27 to alert the ground personnel 27 to the potential damage and request manual inspection. The data indicative of the potential damage is transmitted to the computing system 36 for inclusion in a log entry specific to the aircraft 14 within an aircraft database. By recording such inspection information in the aircraft database, future inspections of that aircraft 14 account for structural repairs or other changes that were properly made during a previous repair of the aircraft 14 but do not constitute damage that would pose a hazard to the aircraft 14.

The robot 32 performs pre/post-flight inspection to identify structural damage based on aircraft scanning data captured by the robot 32. The robot 32 captures scanning data of the aircraft 14 using the sensor 46 and the camera 54 during pre-flight inspection before departure and post-flight inspection after arrival. The computing system 52 processes the scanning data to identify structural damage to the aircraft 14 by comparing captured images and sensor data to reference data for the aircraft 14. The pre/post-flight inspection capability enables identification of damage that occurred during flight operations or ground handling.

The robot 200 is integrated with tow tractors to control the tow tractors before human drivers react when an obstacle is detected. When the robot 200 detects an obstacle during wingwalking operations, the robot 200 sends a signal to the tow tractor to decelerate the speed without human intervention. The computing system 52 processes data from the sensor 46 and the camera 54 to detect obstacles in the path of the aircraft 14 wingtips or other aircraft parts and transmits control signals to the tow tractor via the transceiver 68. The integration with tow tractors enables the robot 200 to initiate deceleration or stopping of the tow tractor before the operator 400 reacts to the detected obstacle, reducing response time and enhancing safety during aircraft movement operations on the airfield 12.

Referring to FIG. 10, a method of inspecting a region of the airfield 12 for foreign-object debris using the robot 32 is depicted as a flowchart illustrating sequential operations from receiving an inspection command through debris detection and data transmission. The method demonstrates an adaptive route generation approach where the robot 32 determines a travel path based on the specific region to be searched rather than following a fixed predefined route.

The step 97 involves receiving a command to inspect a region of the airfield 12 for foreign-object debris. The command is received via the transceiver 68 from the computing system 36 at the control center 34 or from the ground personnel 27 via a mobile terminal such as the smart watch 25. The command includes at least one of an on-demand inspection command and a regular inspection command. On-demand inspection commands are issued in response to the occurrence of a triggering event such as a collision between the aircraft 14 and another object on the airfield 12 or between the service vehicle 24 and another object on the airfield 12. The ground personnel 27 or other airport staff program a fixed foreign-object debris search schedule into the computing system 52 for regular inspection commands. The robot 32 is scheduled to conduct a search for foreign-object debris at a gate before the aircraft 14 is scheduled to arrive at that gate, with such scheduling coordinated with flight information pertaining to inbound and outbound flights.

With continued reference to FIG. 10, the step 99 involves generating a defined route for the robot 32 to travel to arrive at the location where the debris search is to occur. The computing system 52 communicates with the GPS module 62 or other positioning device to determine a current location of the robot 32 relative to the location on the apron 18 and plots a course based on the relative location data. The defined route is adaptive based on conditions when the command is received at the step 97 and is calculated as an ideal route to follow at that time regardless of whether markings are present on the airfield 12 at any point along the ideal route.

As further shown in FIG. 10, the step 101 involves activating and controlling the mobility system 38 to transport the robot 32 along the generated route. The computing system 52 activates the electric motor 42 to drive the wheels 40 and controls operation of the mobility system 38 to transport the robot 32 to the region of the airfield 12 where the search for foreign-object debris is to be conducted. The sensor 46 is operated by the computing system 52 to monitor for obstacles that pose a collision risk along the defined route while the robot 32 is underway.

With continued reference to FIG. 10, the step 105 involves generating a coverage plan to efficiently search the desired region of the airfield 12 for foreign-object debris. The computing system 52 executes coverage planning algorithms to generate a map of a path for the robot 32 to travel to inspect the specified area of the airfield 12 for foreign-object debris. The coverage plan defines a travel path to be traveled by the robot 32 over the region of the airfield 12 to conduct the search for the foreign-object debris. The coverage plan is an adaptive route specific to the region of the airfield 12 to be inspected for foreign-object debris and is generated based on at least one of the geographies of the region of the airfield 12, markings on the region of the airfield 12 to be searched, and LiDAR data captured of adjacent buildings and structures.

As further shown in FIG. 10, the step 107 involves the robot 32 inspecting the region of the airfield 12 according to the coverage plan. The robot 32 travels an adaptive route specific to the region of the airfield 12 to be inspected rather than following a fixed predefined route. The robot 32 determines a route to be traveled while actively searching for the foreign-object debris and adapts as necessary upon encountering obstacles detected while searching. The robot 32 does not follow a fixed, predefined route every time a search for foreign-object debris is to be conducted at the same region of the airfield 12. The adaptive route is specific to the region of the airfield 12 to be inspected for foreign-object debris by the robot 32 based on different geography or shapes of the area for each search and markings on the area for each search.

With continued reference to FIG. 10, the step 109 involves detecting potential foreign-object debris based on LiDAR data and optical image data captured by the sensor circuitry. The sensor 46 captures LiDAR data indicative of shapes of objects on the airfield 12 surface. The camera 54 captures optical images of the airfield 12 surface and foreign-object debris present on the airfield 12. The computing system 52 processes the LiDAR data and the optical image data to detect foreign-object debris on the airfield 12. The monochromatic representations based on LiDAR data are useful to detect a shape of the foreign-object debris, while the camera 54 captures shape data and color data indicative of a color of the potential foreign-object debris detected on the airfield 12.

As further shown in FIG. 10, the step 111 involves using the captured data to recognize and categorize the detected foreign-object debris by comparing shape and color information to reference images stored in a database. The computing system 52 executes optical inspection algorithms to compare data indicative of the shape and color to reference images of known objects commonly found on the airfield 12. The reference images include images of known foreign-object debris rotated to a plurality of different orientations. Matches of shapes and colors to known foreign-object debris in the database are used to improve or further train the optical inspection algorithms for future comparisons. When a shape is not recognized, a matching color is used alone to categorize the detected foreign-object debris into a general category based on the type of material of the foreign-object debris.

With continued reference to FIG. 10, the step 115 involves transmitting data indicative of the foreign-object debris and the location of the foreign-object debris to a remote terminal responsive to detecting foreign-object debris. The transceiver 68 transmits the categorization and identification along with location data to the computing system 36 at the control center 34. The location of the detected foreign-object debris is transmitted to the smart watch 25 or another portable device worn by the ground personnel 27 for manual removal of the detected foreign-object debris. The computing system 36 generates a graphical representation showing images of the detected foreign-object debris labeled by the computing system 52 or the computing system 36.

The robot 32 performs tarmac surface inspection to identify degraded conditions on the airfield 12 including foreign-object debris, potholes, cracks, and lower line marking reflectivity. The sensor 46 and the camera 54 capture data indicative of surface defects such as cracks and potholes in the substantially planar surface of the airfield 12. The computing system 52 processes the captured data to detect anomalies that are deviations from the substantially planar surface of the airfield 12. The laser light source 48 or the light 60 illuminates a region of a marking on the airfield 12 at a known distance in front of the robot 32 for reflectivity inspection. The photodetector 50 or the camera 54 captures a portion of the light reflected by the marking and measures an intensity of the reflected light or another quality indicative of the reflectivity of the marking that was illuminated. Regions of the marking that exhibit little to no reflectivity are deemed to be damaged. A segment of marking that exhibits reflectivity approximately equal to the surrounding surface of the airfield 12 is deemed to be missing due to repeated exposure of the marking to wheels of the aircraft 14 and other vehicles causing removal of the marking from the airfield 12 as a result of wear and tear.

The robot 32 includes a sweeper mat to remove foreign-object debris that is detected on the airfield 12. The sweeper mat collects debris from the surface of the airfield 12 as the robot 32 travels during inspection operations. The sweeper mat operates in conjunction with the magnet 70 to collect both ferromagnetic and non-ferromagnetic debris from the airfield 12 surface.

The robot 200 moves other equipment such as Aircraft Ground Power Unit and equipment boxes from staging areas to where the equipment is needed on the airfield 12. The robot 200 pulls other equipment across the airfield 12 using a coupling mechanism that attaches to the equipment to be transported. The computing system 52 generates a route from the staging area to the destination where the equipment is needed and controls operation of the mobility system 38 to transport the equipment along the generated route.

Referring to FIG. 11, the robot 200 is shown in a state of use inspecting a portion of the aircraft 14 located on the airfield 12. The aircraft 14 is parked on the airfield 12 with the fuselage, wings, tail section, and landing gear visible. The robot 200 is positioned adjacent to the aircraft 14 near a rear landing gear area of the aircraft 14. The positioning of the robot 200 adjacent to the landing gear area enables the robot 200 to inspect the underside of the fuselage, the landing gear components, and the surrounding airfield 12 surface in the vicinity of the aircraft 14.

With continued reference to FIG. 11, the guide markers 30 are illustrated on the surface of the airfield 12 and define a boundary or inspection path around the aircraft 14. The guide markers 30 are shown as dashed lines extending around the perimeter of the aircraft 14. The guide markers 30 provide a reference for the robot 200 to follow during inspection operations. The robot 200 travels along or within the area defined by the guide markers 30 while performing inspection functions relative to the aircraft 14.

The robot 200 follows the guide markers 30 to navigate around the perimeter of the aircraft 14 during inspection operations. The computing system 52 processes images of the guide markers 30 captured by the camera 54 and controls operation of the mobility system 38 to cause the robot 200 to travel along the inspection path defined by the guide markers 30. The robot 200 performs an inspection while traveling the entire distance of the inspection path defined by the guide markers 30, thereby inspecting the entirety of the aircraft 14.

As further shown in FIG. 11, the robot 200 uses real-time proximity data from the sensor 46 to navigate around the perimeter of the aircraft 14 during inspection operations. The computing system 52 uses data generated by the sensor 46 to detect the presence of the aircraft 14 and controls operation of the mobility system 38 to transport the robot 200 about the entire perimeter of the aircraft 14. The real-time proximity data enables the robot 200 to maintain an appropriate distance from the aircraft 14 while navigating around the perimeter and to detect obstacles encountered during the inspection path. The robot 200 adapts the travel path in real-time based on the proximity data to avoid collisions with the aircraft 14, landing gear components, and other objects in the inspection area.

The robot 200 includes equipment pulling capability for moving equipment across the airfield 12. The robot 200 pulls other equipment across the airfield 12 using a coupling mechanism that attaches to the equipment to be transported. The equipment pulling capability enables the robot 200 to transport ground support equipment such as Aircraft Ground Power Units, equipment boxes, and other items from staging areas to locations where the equipment is needed on the airfield 12. The computing system 52 generates a route from the staging area to the destination where the equipment is needed and controls operation of the mobility system 38 to transport the equipment along the generated route while avoiding obstacles detected by the sensor 46.

Referring to FIG. 12, a reference image depicts a portion of an aircraft surface known to be free of damage. The reference image shows the body panels 75 and the rivets 77 of the aircraft surface in an undamaged state. The body panels 75 are shown as distinct sections that form the exterior surface of the aircraft fuselage. The rivets 77 are arranged in rows along the edges of the body panels 75, securing the panels in place. The rivets 77 appear as small circular elements positioned in a pattern that follows the contours of the body panels 75, with one row extending horizontally across an upper portion and another row extending vertically along a right side of the depicted section. A corner region shows where two of the body panels 75 meet, with the rivets 77 forming an L-shaped pattern at this junction. The reference image represents a portion of the aircraft that is properly secured with a full allocation of the rivets 77 as called for by design.

With continued reference to FIG. 12, the reference image serves as a baseline for comparison during inspections performed by the robot 32. The computing system 52 stores the reference image in a database accessible to the computing system 52. The reference image is specific to a particular aircraft model and a particular portion of the aircraft surface. The computing system 52 retrieves the reference image from the database when the robot 32 inspects the corresponding portion of the aircraft 14. The reference image provides a known-good representation of the aircraft surface against which captured images are compared to identify deviations that indicate potential damage.

Referring to FIG. 13, a captured image depicts the same aircraft portion with potential damage detected during inspection. The captured image shows the damaged rivet 80 appearing as a filled circle among a pattern of open circles representing intact rivets arranged in rows across the surface. The damaged rivet 80 represents a rivet that is missing, deformed, or otherwise compromised relative to the intact rivets shown in the reference image of FIG. 12. The computing system 52 detects the damaged rivet 80 by comparing the captured image to the reference image and identifying the deviation in the rivet pattern.

With continued reference to FIG. 13, the body panel deformity 82 is visible as a curved distortion in a lower portion of the captured image. The body panel deformity 82 creates the gap 84 between the deformed panel and the undamaged edge 86 of a neighboring body panel. The gap 84 represents a separation between adjacent body panels that is not present in the reference image of FIG. 12. The undamaged edge 86 of the neighboring body panel provides a reference point for measuring the extent of the gap 84 created by the body panel deformity 82.

As further shown in FIG. 13, the fluid 88 appears to be leaking from the gap 84. The fluid 88 is indicated by diagonal lines suggesting the presence of a substance such as hydraulic fluid emanating from the separation between panels. The presence of the fluid 88 indicates a potential breach in the aircraft structure that allows internal fluids to escape through the gap 84. The computing system 52 detects the fluid 88 by analyzing color and texture information in the captured image and comparing the detected characteristics to known fluid signatures stored in the database.

With continued reference to FIG. 13, the metal patch 94 is shown as a rectangular element with rivets positioned in an upper right portion of the captured image. The metal patch 94 represents a previous repair that has been made to the aircraft surface. The metal patch 94 was installed on a fuselage panel where a crack or other type of damage was previously detected and repaired. The computing system 52 detects the metal patch 94 based on the captured image of that portion of the aircraft 14. The ground personnel 27 input confirmation that the metal patch 94 does not constitute actual damage into a touch-sensitive display device, and in response, the computing system 52 transmits this data point via the transceiver 68 to the computing system 36 at the control center 34. The computing system 36 updates the database to include a log entry specific to the aircraft 14 identified by tail number, including information identifying the metal patch 94 as not constituting actual damage.

The computing system 52 compares captured images to reference images to detect deviations indicating potential damage. The computing system 52 executes optical inspection instructions that compare the captured image of FIG. 13 to the reference image of FIG. 12. The comparison reveals potential damage that appears in the captured image that is not present in the reference image. The computing system 52 identifies the damaged rivet 80, the body panel deformity 82, the gap 84, and the fluid 88 as deviations from the reference image that indicate potential damage requiring attention. Negligible differences between the captured images and the reference images that reflect expected wear and tear and are not considered safety critical are deemed to be acceptable, avoiding the issuance of an alert to the ground personnel 27 or other airport personnel. Detection of substantial differences triggers an alert by an indication system in response to the potential damage being detected by the computing system 52.

The computing system 52 uses generative artificial intelligence instructions to modify optical inspection instructions based on manually identified damage confirmations. The generative artificial intelligence instructions constitute an AI engine that, when executed, modifies the optical inspection instructions to reflect changes that have been manually identified as constituting or not constituting damage. The ground personnel 27 input confirmation via a touchscreen embodiment of a display device that potential damage in the captured image is, in fact, damage requiring repairs. The optical inspection instructions related to the reference image for that portion of the aircraft 14 are automatically modified by the AI engine to reflect this confirmation. The AI engine is a trained model that modifies the optical inspection instructions in response to known data concerning damage. The AI engine suggests modifications to the optical inspection instructions after the optical inspection instructions identify a statistically-significant number of common forms of damage.

The camera 54 captures an image of a face of the ground personnel 27 for facial recognition or executes a code-scanner function to read a barcode, magnetic strip, or other computer-readable code on a security badge worn by the ground personnel 27. Prior to accepting input from the ground personnel 27 confirming that potential damage is actual damage or that a repair such as the metal patch 94 does not constitute damage, the camera 54 captures an image of the face of the ground personnel 27 for facial recognition. The computing system 52 processes the captured facial image and compares the facial image to stored facial recognition data to verify the identity of the ground personnel 27 providing the input. The camera 54 executes a code-scanner function that reads a barcode or magnetic strip on a security badge worn by the ground personnel 27 to verify credentials. The facial recognition and code-scanner functions verify that the ground personnel 27 providing damage confirmations are authorized personnel with appropriate security clearance to access the airfield 12 and provide inspection input. The camera 54 routinely conducts facial recognition or other identification confirmation processes to detect unauthorized personnel on the airfield 12.

Referring to FIG. 14, the graphical representation 55 depicts a portion of the airfield 12 containing foreign-object debris labeled by the computing system 52. The graphical representation 55 is displayed within a window interface showing a view of an airfield surface with runway markings visible as diagonal lines. The graphical representation 55 is generated by the computing system 36 at the control center 34 or by the computing system 52 of the robot 32 and is transmitted to remote terminals for display to the ground personnel 27.

With continued reference to FIG. 14, the zipper 57 is shown enclosed by the virtual rectangle 59. The label 61 displays “ZIPPER” to indicate the positive identification of this foreign-object debris. The computing system 52 positively identifies the zipper 57 by comparing shape and color data captured by the camera 54 and the sensor 46 to reference images of known objects stored in a database. The positive identification by the computing system 52 is designated by the label 61 describing the specific type of foreign-object debris identified. The virtual rectangle 59 highlights the location of the zipper 57 within the graphical representation 55 to direct attention of the ground personnel 27 to the detected debris.

As further shown in FIG. 14, the luggage tag 67 appears in a lower portion of the graphical representation 55. The luggage tag 67 is enclosed by the rectangle 69. The label 71 displays “TAG” to designate the identified debris. The computing system 52 positively identifies the luggage tag 67 by matching shape and color characteristics of the detected object to reference images of luggage tags stored in the database. The rectangle 69 and the label 71 provide visual indication to the ground personnel 27 of the type and location of the detected foreign-object debris.

With continued reference to FIG. 14, the unidentifiable object 81 is shown enclosed by the virtual rectangle 85. The label 87 displays “METAL” to indicate the general category classification of this debris based on detected color. The computing system 52 is unable to make a positive identification of the unidentifiable object 81 by comparing the shape of the unidentifiable object 81 to reference images in the database. When a positive identification is not made, the computing system 52 uses detected color data to categorize the unidentifiable object 81 into a general category based on the type of material of the foreign-object debris. The color of the unidentifiable object 81 corresponds to metallic materials, and the computing system 52 assigns the general category classification of metal to the unidentifiable object 81 as indicated by the label 87.

The computing system 52 categorizes and labels detected debris for transmission to remote terminals and display to the ground personnel 27. The transceiver 68 transmits the graphical representation 55 including the categorization and identification information along with location data to the computing system 36 at the control center 34. The computing system 36 distributes the graphical representation 55 to portable communication devices such as the smart watch 25 worn by the ground personnel 27. The location of each detected foreign-object debris item is transmitted to enable the ground personnel 27 to navigate to the debris location for manual removal. The graphical representation 55 provides the ground personnel 27 with visual confirmation of the type and location of foreign-object debris detected by the robot 32 during inspection operations on the airfield 12.

The robot 32 inspects markings on the airfield 12 for retroreflectivity compliance with FAA regulations and ASTM E1710 standards. The laser light source 48 or the light 60 illuminates a portion of a marking on the airfield 12 at a known distance in front of the robot 32 for retroreflectivity testing. The robot 32 illuminates a portion of the marking approximately 30 meters ahead of the robot 32 for retroreflectivity testing. The photodetector 50 or the camera 54 captures a portion of the light reflected by the marking and measures an intensity of the reflected light or another quality indicative of the reflectivity of the marking that was illuminated.

The light source for marking inspection is positioned at approximately 0.65 meters above the airfield 12 and the sensor is positioned at approximately 1.2 meters above the airfield 12 for ASTM E1710 compliance. The positioning of the light source and the sensor in compliance with ASTM E1710 enables the robot 32 to measure retroreflectivity of markings in accordance with testing standards promulgated by ASTM International. The light emitted toward the marking under inspection has a known angle of incidence based on the elevation of the light source and the distance to the illuminated portion of the marking. The computing system 52 processes the measured reflectivity data and determines whether the marking under inspection is compliant with ASTM E1710 or other applicable regulations. The computing system 52 generates an alert that is transmitted by the transceiver 68 to the computing system 36 or other maintenance system in response to detecting a portion of the marking that exhibits reflectivity below a permissible threshold. The alert includes coordinates or other information identifying a location of the degraded portion of the marking so the ground personnel 27 or maintenance staff are dispatched to effectuate repairs to the degraded marking.

Referring to FIG. 15, the computing system 98 is configured to implement the disclosed systems and methods for aircraft wingwalking automation, aircraft inspection, and foreign-object debris detection on the airfield 12. The computing system 98 serves as an embodiment of the computing system 36 at the control center 34 and the computing system 52 provided to the robot 32 and the robot 200. The computing system 98 includes the processor 100 and the memory 102 operably connected by the bus 106. The bus 106 provides communication pathways between the various components of the computing system 98, enabling data transfer between the processor 100, the memory 102, and other components.

With continued reference to FIG. 15, the processor 100 executes computer-executable instructions to perform the functions disclosed herein including controlling operation of the mobility system 38, processing sensor data from the sensor 46 and the camera 54, executing perception algorithms for aircraft identification, and generating navigation routes for the robot 32 and the robot 200. The processor 100 includes dual microprocessor and other multi-processor architectures. The memory 102 includes volatile memory and non-volatile memory. Non-volatile memory includes ROM and PROM. Volatile memory includes RAM, SRAM, and DRAM. The memory 102 stores the process 116 and the data 112 for execution by the processor 100.

As further shown in FIG. 15, the I/O port 104 is connected to the bus 106 and facilitates input and output operations for the computing system 98. The I/O port 104 includes serial ports, parallel ports, and USB ports. The I/O interface 114 is coupled to the I/O port 104 and enables the computing system 98 to interact with external devices. The computing system 98 interacts with input and output devices via the I/O interface 114 and the I/O port 104. Input and output devices include keyboards, microphones, pointing and selection devices, cameras, video cards, displays, the disk 110, and the network devices 118.

With continued reference to FIG. 15, the disk 110 is operably connected to the computing system 98 via the I/O interface 114 and the I/O port 104. The disk 110 provides storage capabilities for the computing system 98. The disk 110 includes a magnetic disk drive, a solid-state disk drive, a floppy disk drive, a tape drive, a Zip drive, a flash memory card, a memory stick, a solid-state storage device, a flash drive, a CD-ROM drive, a CD-R drive, a CD-RW drive, and a DVD-ROM. The disk 110 and the memory 102 store an operating system that controls and allocates resources of the computing system 98. The disk 110 stores reference images of aircraft portions known to be free of damage, reference images of known foreign-object debris, flight schedule information, and aircraft database entries including log entries specific to individual aircraft identified by tail number.

As further shown in FIG. 15, the network devices 118 are connected to the I/O interface 114 and the I/O port 104. The network devices 118 provide network connectivity for the computing system 98. The computing system 98 operates in a network environment and is connected to the network devices 118 via the I/O interface 114 and the I/O port 104. Through the network devices 118, the computing system 98 interacts with a network. Through the network, the computing system 98 is logically connected to remote computers. Networks with which the computing system 98 interacts include a local area network (LAN), a wide area network (WAN), and other networks. The computing system 98 communicates with the control center 34, the mobile device 500, the smart watch 25, and other devices through the network devices 118.

With continued reference to FIG. 15, the logic 108 is connected to the bus 106 and is configured to control operation of the robot 32 and the robot 200. The logic 108 is implemented in hardware, a non-transitory computer-readable medium with stored instructions, firmware, or combinations thereof to perform the functions disclosed herein. The logic 108 is implemented in the processor 100, stored in the memory 102, or stored in the disk 110. The logic 108 includes firmware, a microprocessor programmed with an algorithm, discrete logic such as an application-specific integrated circuit (ASIC), at least one circuit, an analog circuit, a digital circuit, a programmed logic device, and a memory device containing instructions of an algorithm configured to perform the disclosed functions.

As further shown in FIG. 15, the logic 108 controls operation of the mobility system 38, the electric motor 42, the sensor 46, the laser light source 48, the photodetector 50, the camera 54, the adjustable mount 56, the light 60, the GPS module 62, a display device, the transceiver 68, and the magnet 70. The logic 108 includes one or more gates, combinations of gates, or other circuit components configured to perform the disclosed functions. Where multiple logics are described, incorporation of the multiple logics into one logic is possible. Where a single logic is described, distribution of that single logic between multiple logics is possible.

With continued reference to FIG. 15, the process 116 and the data 112 are shown external to the computing system 98 and represent executable instructions and information stored in the memory 102 or the disk 110. The process 116 includes the optical inspection instructions, the coverage planning algorithms, the perception algorithms for multi-modal aircraft identification, and the generative artificial intelligence instructions for modifying optical inspection instructions based on damage confirmations. The data 112 includes sensor data captured by the sensor 46 and the camera 54, proximity data, damage data, foreign-object debris detection data, location data from the GPS module 62, and flight schedule information received from the control center 34.

The computing system 98 is a server operating in a cloud computing system, a server configured in a Software as a Service (SaaS) architecture, a smartphone, a laptop, a mobile device computing device, or other computing device. The computing system 98 executes computer-executable instructions stored in a non-transitory computer-readable medium. The non-transitory computer-readable medium stores instructions and data configured to perform the disclosed functions when executed by at least a single processor. The non-transitory computer-readable medium includes non-volatile media and volatile media. Non-volatile media includes optical disks and magnetic disks. Volatile media includes semiconductor memories and dynamic memory. Common forms of the non-transitory computer-readable medium include a floppy disk, a flexible disk, a hard disk, a magnetic tape, other magnetic medium, an ASIC, a programmable logic device, a compact disk, other optical medium, RAM, ROM, a memory chip or card, a memory stick, a solid-state storage device, a flash drive, and other media from which a computer, a processor, or other electronic device functions.

A display device of the robot 32 and the robot 200 is an LED computer screen within a weather-resistant protective case, an array of LED indicator lights, or an individual LED light source. The LED computer screen within the weather-resistant protective case displays graphical information including images of portions of the aircraft 14 that triggered alerts, descriptions of potential damage, locations of potential damage, and remedial action to address the potential damage. The array of LED indicator lights emits visible signals in response to detection of foreign-object debris, potential damage to the aircraft 14, or obstacles encountered during navigation. The individual LED light source creates a strobe effect, alters a color of light emitted, or otherwise generates a high-visibility alert while the robot 32 or the robot 200 is in motion traveling between locations on the airfield 12 to protect against collisions with other vehicles such as the aircraft 14 and the service vehicle 24.

FIG. 1 depicts the robot 200 including the wheels 240, the laser light source 248, the photodetector 250, the photodetector 252, the photodetector 254, the GPS/IMU sensor 260, the contact sensor 270, and the camera 274. The robot 200 is omnidirectional, meaning the robot 200 moves in eight directions and performs zero-radius turns. The robot 200 uses centimeter precision localization for autonomous navigation in the airfield environment. The robot 200 autonomously navigates both indoor and outdoor airfield environments including hangar, gate, apron, taxiway, and runway areas. The contact sensor 270 is mounted to the robot 200 for sensing contact with an object. The camera 274 allows visual and infrared monitoring during the day or at night. The photodetector 250, the photodetector 252, and the photodetector 254 are positioned at different locations on the robot 200 for detecting reflected laser light from various directions. The robot 200 is powered by an onboard battery, internal combustion engine, or similar power source.

FIG. 2 depicts the robot 200, the aircraft 300, the operator 400, the mobile device 500, the charging station 501, and the headset 503. The mobile device 500 is wirelessly connected to the robot 200 for issuing commands. The headset 503 is paired or connected to the mobile device 500 for receiving audio alerts. Upon clicking a summon button, the robot 200 autonomously finds a way to the summoning mobile device 500. Upon clicking a deployment button, the robot 200 identifies two wingtips or two other aircraft parts of the aircraft 300 and positions itself next to each wingtip or specific aircraft part. Upon clicking a complete button, the robot 200 autonomously returns to the charging station 501 and plugs into charging ports. The robot 200 tracks and follows the wingtips or other aircraft parts in real-time once the aircraft 300 starts moving. The robot 200 autonomously plugs into charging ports similar to a Roomba vacuum cleaner.

FIG. 3 depicts the mobile device 500, the left pane 502, and the right pane 504. The left pane 502 displays alerts for four different parts of the aircraft: left wing, right wing, tail, and ground. The mobile device 500 displays divided screens for showing semantic information and surround information separately. The alert system is synchronized across robot onboard LEDs, robot sound alerts, the mobile device 500 semantic information display, and the headset 503 sound alerts. Robot onboard LEDs turn orange or red when an obstacle is detected in a wing's direction.

FIG. 4 depicts the mobile device 500, the left pane 506, and the right pane 504. The surround information includes real-time camera footage and 3D LiDAR footage. The left pane 506 and the right pane 504 provide detailed sensing information around the aircraft during wingwalking operations.

FIG. 5 depicts the method 600 including the step 602, the step 604, the step 606, the step 608, the step 610, the step 612, the step 614, the step 616, and the step 618. The system supports multiple robots and multiple mobile devices operating simultaneously. An orchestration system receives summoning commands from mobile devices and dispatches multiple robots to the issuing mobile device.

FIG. 6 depicts the airport 10, the airfield 12, the aircraft 14, the runway 16, the apron 18, the taxiway 20, the service road 22, the service vehicle 24, the smart watch 25, the taxi lines 26, the ground personnel 27, the jet bridge 28, the guide markers 30, the control center 34, the computing system 36, the gate G1, the gate G2, the gate G3, and the gate G4. The guide markers 30 include electric conductors such as wires or circuitry buried beneath the surface of the airfield 12. The computing system 36 transmits sensor data to update a real-time digital twin of the airfield 12 for coordinating ground operations. The computing system 36 distributes content generated as part of the digital twin over a local area network or wide area network to robots, the service vehicle 24, and portable communication devices such as the smart watch 25.

FIG. 7 depicts the robot 32, the mobility system 38, the wheels 40, the electric motor 42, the chassis 44, the sensor 46, the laser light source 48, the photodetector 50, the computing system 52, the camera 54, the adjustable mount 56, the light 60, the GPS module 62, the photodetectors 64, the support structure 66, the transceiver 68, and the magnet 70. The robot 32 identifies different parts of an aircraft including fuselage, wings, tails, and landing gears using multi-modal sensor configuration and perception algorithms. The adjustable mount 56 is controlled by the computing system 52 to vary a sight line of the camera 54 between the surface of the airfield 12 and the underside of an aircraft fuselage. The magnet 70 is a permanent magnet or an electromagnet that is selectively activated. The robot 32 performs pre/post-flight inspection to identify structural damage based on aircraft scanning data. The robot 32 performs tarmac surface inspection to identify degraded conditions like foreign-object debris, potholes, cracks, and lower line marking reflectivity. The robot 32 pulls other equipment across the airfield 12. The robot 32 includes a sweeper mat to remove foreign-object debris that is detected. The robot 32 moves other equipment such as Aircraft Ground Power Unit and equipment boxes from staging areas to where the equipment is needed. The wingwalking robot 32 is integrated with tow tractors to control the tow tractors before human drivers react, such as decelerating speed when an obstacle is detected. The robot 32 uses a continuous track system instead of the wheels 40 for mobility. A debris collector comprises at least one magnet 70, a vacuum, and a broom for collecting foreign objects.

FIG. 8 depicts the robot 32, the mobility system 38, the wheels 40, the chassis 44, the sensor 46, the laser light source 48, the photodetector 50, the computing system 52, the camera 54, the light 60, the photodetectors 64, the support structure 66, the transceiver 68, the magnet 70, and the proximity sensor 65. The robot 32 uses ultrasonic, capacitive, or other types of proximity sensors as added defense against collisions. A navigation system uses virtual waypoints in a positioning system that uses data from navigation satellites or terrestrial transmitters.

FIG. 9 depicts the step 72, the step 74, the step 76, the step 78, the step 79, the step 90, the step 92, and the step 96. The computing system 52 uses generative artificial intelligence instructions to modify optical inspection instructions based on manually identified damage confirmations. The camera 54 captures an image of a face of the ground personnel 27 for facial recognition or executes a code-scanner function to read a barcode or magnetic strip on a security badge.

FIG. 10 depicts the step 97, the step 99, the step 101, the step 105, the step 107, the step 109, the step 111, and the step 115. The robot 32 executes coverage planning to generate a map of a path for searching a specified area of the airfield 12 for foreign-object debris. The robot 32 travels an adaptive route specific to the region of the airfield 12 to be inspected rather than following a fixed predefined route.

FIG. 11 depicts the airfield 12, the aircraft 14, the guide markers 30, and the robot 200. The robot 200 inspects markings on the airfield 12 for retroreflectivity compliance with FAA regulations and ASTM E1710 standards. A light source for marking inspection is positioned at approximately 0.65 meters above the airfield 12 and the sensor 46 is positioned at approximately 1.2 meters above the airfield 12 for ASTM E1710 compliance. The robot 200 illuminates a portion of a marking approximately 30 meters ahead for retroreflectivity testing.

FIG. 12 depicts the body panels 75 and the rivets 77. The body panels 75 and the rivets 77 represent a portion of an aircraft surface known to be free of damage for comparison during inspection operations.

FIG. 13 depicts the damaged rivet 80, the body panel deformity 82, the gap 84, the undamaged edge 86, the fluid 88, and the metal patch 94. The damaged rivet 80, the body panel deformity 82, the gap 84, and the fluid 88 represent potential damage detected by comparing captured images to reference images.

FIG. 14 depicts the graphical representation 55, the zipper 57, the virtual rectangle 59, the label 61, the luggage tag 67, the rectangle 69, the label 71, the unidentifiable object 81, the virtual rectangle 85, and the label 87. The graphical representation 55 displays foreign-object debris detected on the airfield 12 with identification labels and location information.

FIG. 15 depicts the computing system 98, the processor 100, the memory 102, the I/O port 104, the bus 106, the logic 108, the disk 110, the data 112, the I/O interface 114, the process 116, and the network devices 118. A display device is an LED computer screen within a weather-resistant protective case, an array of LED indicator lights, or an individual LED light source.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An automation system for aircraft wingwalking, comprising:
at least one autonomous mobile robot configured to perform wingwalking functions, each autonomous mobile robot of the at least one autonomous mobile robot including:
a mobility system operable to transport the robot over a ground surface of an airfield;
sensor circuitry supported by the mobility system, the sensor circuitry including a proximity sensor configured to capture proximity data indicative of a presence of an aircraft and obstacles adjacent to the robot, and at least one camera configured to capture image data of an environment surrounding the robot; and
a computing system configured to execute computer-executable instructions to detect the presence of the aircraft based on the proximity data, identify a specific part of the aircraft using sensor data from the sensor circuitry, and control operation of the mobility system to autonomously navigate the airfield and position the robot adjacent to a respective part of the aircraft;
a user-interface mobile device wirelessly connected to the at least one autonomous mobile robot, the mobile device configured to receive commands from an operator and transmit the commands to the at least one autonomous mobile robot, the mobile device including a deployment control that, when activated, causes the at least one autonomous mobile robot to identify the specific part of the aircraft and autonomously position the at least one autonomous mobile robot adjacent to the specific aircraft part, and subsequently track and follow the specific aircraft part as the aircraft moves; and
an indication system configured to provide alerts to the operator based on obstacle detection by the at least one autonomous mobile robot during aircraft movement.

2. The automation system of claim 1, wherein the mobile device further includes a summon control that, when activated, causes the at least one autonomous mobile robot to navigate to a location associated with the mobile device.

3. The automation system of claim 2, wherein the mobile device further includes a complete control that, when activated, causes the at least one autonomous mobile robot to autonomously navigate to a charging station and plug into respective charging ports.

4. The automation system of claim 1, wherein the mobile device is configured to display semantic information showing alerts for different parts of the aircraft including left wing, right wing, tail, and ground.

5. The automation system of claim 1, wherein the mobile device is configured to display surround information including real-time sensing information comprising camera footage and three-dimensional LiDAR footage.

6. The automation system of claim 1, wherein the indication system includes robot onboard LED alerts, robot sound alerts, mobile device display alerts, and headset sound alerts that are synchronized to indicate obstacle proximity.

7. The automation system of claim 6, wherein the indication system is configured such that when an obstacle is detected in the pathway of the aircraft, the robot onboard LED alerts change color to orange or red, the robot sound alerts activate, a corresponding section of a mobile device semantic information display changes to orange or red, and the headset sound alerts activate.

8. The automation system of claim 1, wherein the mobility system of each robot is omnidirectional to enable movement in multiple directions and zero-radius turns.

9. The automation system of claim 1, wherein the proximity sensor includes a light detection and ranging sensor having a laser light source and a plurality of photodetectors configured to detect reflected laser light from objects on the airfield.

10. The automation system of claim 1, wherein the computing system of each robot is configured to identify different parts of the aircraft including fuselage, wings, tails, and landing gears using multi-modal sensor configuration and perception algorithms.

11. The automation system of claim 1, further comprising an orchestration system configured to receive a summoning command from the mobile device and dispatch the at least one autonomous mobile robot to the mobile device that issues the summoning command, wherein the orchestration system is configured to manage the plurality of autonomous mobile robots and multiple mobile devices.

12. A method for automated aircraft wingwalking of an aircraft, comprising:
receiving, at an orchestration system, a summon command from a mobile device associated with a tow tractor;
dispatching, by the orchestration system, at least one autonomous mobile robot to the mobile device that issued the summon command;
receiving, at the at least one autonomous mobile robot, a deployment command from the mobile device;
identifying, by each robot of the at least one autonomous mobile robot, an aircraft part using sensor circuitry of each robot;
autonomously positioning, by each robot, adjacent to the respective identified aircraft part;
tracking, by each robot, the respective aircraft part in real-time and autonomously following the aircraft part while the aircraft is moving;
displaying, on the mobile device, information captured by the at least one autonomous mobile robot; and
issuing alerts from at least one of the at least one autonomous mobile robot and the mobile device according to detected obstacle conditions.

13. The method of claim 12, wherein displaying information captured by the at least one autonomous mobile robot includes displaying semantic information showing alerts for four different parts of the aircraft comprising left wing, right wing, tail, and ground.

14. The method of claim 13, wherein displaying information captured by the at least one autonomous mobile robot further includes displaying surround information comprising real-time camera footage and three-dimensional LiDAR footage.

15. The method of claim 12, wherein issuing alerts includes synchronizing robot onboard LED alerts, robot sound alerts, mobile device display alerts, and headset sound alerts.

16. The method of claim 15, further comprising, when an obstacle is detected in a pathway of the aircraft, changing robot onboard LEDs to orange or red, activating robot sound alerts, changing a corresponding section of a mobile device semantic information display to orange or red, and activating headset sound alerts.

17. An autonomous mobile robot for aircraft wingwalking, comprising:
a mobility system operable to transport the robot over a ground surface of an airfield;
sensor circuitry supported by the mobility system, the sensor circuitry including a light detection and ranging sensor having a laser light source and a plurality of photodetectors configured to detect reflected laser light from objects on the airfield, and at least one camera configured to capture image data;
a computing system configured to execute computer-executable instructions to detect a presence of an aircraft based on proximity data from the sensor circuitry, identify a specific part of the aircraft using data from the sensor circuitry, control operation of the mobility system to autonomously position the robot adjacent to the specific part of the aircraft, and track and follow the specific part of the aircraft during aircraft movement;
a wireless transceiver configured to communicate with a user-interface mobile device to receive commands and transmit sensor data; and
an indication system configured to provide alerts based on obstacle detection during aircraft movement.

18. The autonomous mobile robot of claim 17, wherein the robot is configured to autonomously navigate to a charging station and plug into a charging port in response to a complete command received via the wireless transceiver.

19. The autonomous mobile robot of claim 18, wherein the robot is configured to autonomously navigate to a location associated with the user-interface mobile device in response to a summon command received via the wireless transceiver.

20. The autonomous mobile robot of claim 17, wherein the sensor circuitry further includes a GPS/IMU sensor configured to provide positioning and orientation data for centimeter precision localization during autonomous navigation of the airfield.
